(19) United States
(12) Patent Application Publication
(10) Pub. No.: US 2025/0107543 A1
(43) Pub. Date: Apr. 3, 2025

(54) TREATMENT OF AGRICULTURAL, FOOD AND RELATED PRODUCTS FOR ELIMINATING CONTAMINANTS AND ENCHANCING SHELF-LIFE

(71) Applicant: Deepa Vidyadhar BHAJEKAR, Thane West (IN)

(72) Inventor: Deepa Vidyadhar BHAJEKAR, Thane West (IN)

(73) Assignee: Deepa Vidyadhar BHAJEKAR, Thane West (IN)

(21) Appl. No.: 18/729,899

(22) PCT Filed: Jan. 19, 2023
(86) PCT No.: PCT/IN2023/050060

§ 371 Date: Jul. 18, 2024

(30) Foreign Application Priority Data
Jan. 20, 2022 (IN) 202221003425

(51) Int. Cl. A23B 7/152; A23B 2/00; A23B 2/704; A23B 2/721; A23B 2/91; A23B 7/02; A23B 7/022; A23B 9/08; A23B 9/22

(52) U.S. Cl. CPC A23B 7/152; A23B 2/001; A23B 2/7045; A23B 2/721; A23B 2/91; A23B 7/0205; A23B 7/022; A23B 9/08; A23B 9/22

(57) ABSTRACT

The subject matter described herein relates to systems for treatment of a product for decontamination of the product. The product may include agricultural, food and related product. The system comprises a decontamination chamber (102, 102-1) having an inlet (120, 120-2) to receive the product; multiple first channels (143, 202, 302, 402, 602, 702) in the decontamination chamber (102), wherein the multiple first channels (143, 202, 302, 402, 602, 702) are distributed across the longitudinal span of the decontamination chamber (102, 102-1); a trioxygen generator (106) with a feedline (128) coupled to the multiple first channels (143, 202, 302, 402, 602, 702), wherein the trioxygen generator (106) is to provide trioxygen gas to the multiple first channels (143, 202, 302, 402, 602, 702) to disseminate trioxygen gas onto the product in the decontamination chamber (102, 102-1); and an outlet (145, 145-2) to output the trioxygen treated product.

### FIELD OF INVENTION

The present subject matter describes systems with mechanisms to disburse gas, liquids, or gas and liquids for batch, continuous, semi-continuous treatment of a wide range of agricultural or food or other related products, including, but not limited to, grains, seeds, nuts, spices, fruits, dried green leafy vegetables, herbs and grasses encompassing all agricultural whole and ground commodities, packaged foods, products of animal origin (non-vegetarian), for elimination of contaminants, including bacteria, fungi, their toxins and metabolites, insects and larvae, and enhancing the shelf-life of the products.

### BACKGROUND

All tropical countries have agriculture as their primary economy. Practices for harvesting of individual crops remain similar in the different countries given the fact that the cutting, drying and time required for maturity to achieve the desired characteristics in the crop and the final moisture content remain the same globally. From the harvesting stage to storage to consumption, contamination can occur at each stage affecting the quality of the produce rendering it unsafe for consumption.

As of date, no commercially viable and scalable processes are available for treatment of harvested agricultural produce to reduce specific chemical contaminants such as fungal metabolites and microbial pathogens both of which are hazardous and can develop over a period of time. No scaled-up commercial systems are available which dispense multiple formats of treatment agents for decontamination of large volumes of agricultural produce post-harvest.

Multiple technologies have been studied on a small scale, including: (a) cold plasma generation; (b) alternative fungal and bacterial cultures which compete for the same nutrients keeping the problematic microbes at bay; (c) ultraviolet (UV) light rays of different nanometers; (d) mixture of gases such as nitrogen, carbon dioxide among others to limit microbial growth; (e) chlorine and H₂O₂ based sanitizing chemicals; (f) alcohol washes to cleanse; and (g) trioxygen in gaseous and aqueous form.

Looking at the viability, scalability and safety of direct exposure to food commodities, including safety of handling in bulk quantities, trioxygen seems promising. Trioxygen leaves behind no residue and can be used in gaseous form and dissolved in water. It has been observed that handling of trioxygen in small quantities for laboratory experiment was feasible. However, practically, if the same are to be used at a larger scale, there would be toxicity challenges in the surrounding air and atmosphere. The other challenge is the long time period required for effective decontaminated outcome.

Another conventional process employs a batch processing for treatment of grains, employing discontinuous flow of grains in a chamber injected with predetermined concentration of trioxygen. This process is designed specifically for production of flours and pretreating wheat grains prior to milling. Said conventional process employs treatment rate at 2 to 12 grams of trioxygen per kg grains conjugated with 0.5 to 2 bar pressure of trioxygen and added moisture up to 1 to 5% of grain weight. Further, said conventional process separates the pericarp of wheat grains yielding a fraction rich in fibers. Separation of pericarp during the process claims to further reduce energy and cost inputs for milling of grains and imparts considerable control over flour properties.

### OBJECT OF INVENTION

The present subject matter describes systems for treatment of large volumes of agricultural, food, and other related products using trioxygen and liquid and air, sequentially or simultaneously, to effectively decontaminate the product from multiple contaminants. The systems of the present subject matter are scalable and viable for a commercial scale operation. The systems of the present subject matter allays shortcomings of conventional technologies by treatment of agricultural, food and other related products, demonstrating destruction of various contaminants, enhancing shelf life and preservation of original organoleptic characteristics of said products post treatment. The agricultural, food, and other related products may include, but are not limited to, grains, seeds, nuts, spices, fruits, dried green leafy vegetables, herbs and grasses encompassing all agricultural whole and ground commodities, packaged foods, products of animal origin (non-vegetarian).

It is important to keep in mind the safety of personnel handling, safety of the environment, time period of treatment, impact on nutritional characteristics of the material being treated, functionality of the product post treatment, aesthetics and taste of the product post treatment. The conventional systems and methods do not incorporate some of the parameters described above, having direct implications to the operational use of the conventional systems and methods in actual practice.

An object of the present subject matter is to solve multiple quality problems and deactivate chemical contaminants, such as fungal metabolites and microbial pathogens, in a combined mechanical process that is environmentally safe and can work in dry and wet forms of application. The systems of the present subject matter are feasible to treat product in a short period of time and is safe for the handlers and for the food product.

### BRIEF DESCRIPTION OF THE ACCOMPANYING DRAWING

The disclosure will now be described with the help of the accompanying drawings, in which the numbers given below indicates system parts.

FIG. 1. illustrates a schematic representation of a system for treatment of a product for decontamination of the product, in accordance with an example.

FIG. 2. illustrates a schematic representation of a system for treatment of a product for decontamination of the product, in accordance with an example.

FIG. 3. illustrates a schematic representation of a system for treatment of a product for decontamination of the product, in accordance with an example.

FIG. 4. illustrates a schematic representation of a system for treatment of a product for decontamination of the product, in accordance with an example.

FIG. 5. illustrates an example schematic representation of a drying chamber that can be optionally used with the systems of FIG. 1, FIG. 2, FIG. 3, or FIG. 4 for treatment of a product for decontamination of the product, in accordance with an example.

FIG. 6. illustrates a schematic representation of a system for treatment of a product for decontamination of the product, in accordance with an example.

FIG. 7. illustrates a schematic representation of a system for treatment of a product for decontamination of the product, in accordance with an example.

FIG. 8. illustrates an example schematic representation of a conveyor means and a liquid dispensing line for the systems of FIG. 6 and FIG. 7.

### DETAILED DESCRIPTION

The present disclosure describes systems which are scalable and viable for multiple decontamination of an agricultural, food and other related product from microbial pathogens such as Salmonella and Escherichia coli, fungal metabolites such as Mycotoxins including and fungi including Aspergillus flavus and Aspergillus parasiticus, weevils and pesticides associated with such products on a commercial scale. The systems of the present subject matter involve decontaminating a pre-conditioned agricultural, food and other related product using very low levels of trioxygen gas under pressure and combined with an efficient design of homogeneous disbursal of trioxygen gas and pre-conditioning liquid on the product. The agricultural, food and other related product may include, but is not limited to, grains, seeds, nuts, spices, fruits, dried green leafy vegetables, herbs and grasses encompassing all agricultural whole and ground commodities, packaged foods, products of animal origin (non-vegetarian). The contaminants that are eliminated may include, but not limited to, bacteria, fungi, their toxins and metabolites, insects and larvae.

In an example, the system of the present subject matter comprises a decontamination chamber having an inlet to receive the product. The system also comprises multiple first channels in the decontamination chamber, where the multiple first channels are distributed across the longitudinal span of the decontamination chamber. The system further comprises a trioxygen generator with a feedline coupled to the multiple first channels. The trioxygen generator is configured to provide trioxygen gas to the multiple first channels to disseminate trioxygen gas onto the product in the decontamination chamber. In an example, the trioxygen gas may be disseminated one or more times. In an example, the trioxygen gas may be disseminated at a pressure of 1 to 2 bar. The system further comprises an outlet to output the trioxygen treated product.

The multiple first channels may have orifices, with or without respective meshes (to avoid the product to enter the orifices in the channels), through which trioxygen gas is disseminated onto the product in the decontamination chamber. The orifices may be of a size in a range of about 0.2 mm to about 90 mm, and one or more of the orifices may have a mesh to control the product, being treated, from entering the orifices.

In an example, the multiple first channels comprise: at least one longitudinal channel coupled to the feedline and having orifices to disseminate trioxygen gas onto the product in the decontamination chamber; and a set of sub-channels coupled to the at least one longitudinal channel and having orifices to disseminate trioxygen gas onto the product in the decontamination chamber. Each sub-channel of the set of sub-channels subtends an angle in a range of about 30° to about 90° with respect to the respective longitudinal channel. The orifices in the at least one longitudinal channel and in the set of sub-channels are of a size in a range of about 0.2 mm to about 90 mm, and one or more of these orifices may have a mesh to control the product, being treated, from entering the orifices. The system may further comprise a hot air compressor coupled to the feedline. The hot air compressor is to provide hot air to the product in the decontamination chamber via the orifices of the at least one longitudinal channel and the set of sub-channels. In an example, the at least one longitudinal channel has a cross-sectional dimension in a range of about 10 cm to about 50 cm.

Further, the at least one longitudinal channel may be coupled to the liquid disseminator to receive the pre-conditioning liquid and disseminate the pre-conditioning liquid onto the product via the orifices of the at least one longitudinal channel and also via the orifices of the set of sub-channels. Further, the system may comprise a gear box coupled to the feedline and the at least one longitudinal channel. The gear box is to rotate the at least one longitudinal channel and the set of sub-channels for movement of the product inside the decontamination chamber.

In an example, the system may comprise: a liquid disseminator that holds a pre-conditioning liquid comprising H2O2 or HOCl or H2O or citric acid or sodium bicarbonate or a combination thereof; and at least one second channel lined inside the decontamination chamber along a longitudinal dimension of the decontamination chamber. The at least one second channel has orifices and is coupled to the liquid disseminator to receive the pre-conditioning liquid and disseminate the pre-conditioning liquid onto the product via the orifices. The orifices in the at least one second channel are of a size in a range of about 0.1 mm to about 50 mm, and one or more of these orifices may have a mesh to control the product, being treated, from entering the orifices.

In an example, the system may additionally comprise a chiller, a hot air compressor, a pre-conditioning chamber (separate from the decontamination chamber), a trioxygen destructor for converting unused trioxygen gas into oxygen, a liquid dispensing system in the decontamination chamber and/or in the pre-conditioning chamber for homogenous distribution of pre-conditioning liquid onto the product. In an example, the pre-conditioning liquid may include, but is not limited to, H₂O₂ or HOCl or H₂O or citric acid or sodium bi-carbonate or a combination thereof.

In an example, the decontamination chamber may have a conveying means selected from rotational, vibratory, oscillatory, anti-gravity, sliding means, internal movement of material with a variety of baffles. The decontamination chamber may be rotated, vibrated, oscillated or moved in any other way to move the product inside the decontamination chamber and the trioxygen gas and/or the pre-conditioning liquid may be disseminated onto the product while the product is in motion for uniform distribution of trioxygen gas and/or pre-conditioning liquid.

In an example, the system may include innovative strips of detection paper to detect the activation and deactivation of trioxygen gas in the decontamination chamber.

In an example, the agricultural, food and other related products that can be treated using the systems described herein, include, but are not limited to, any whole grains, cereals, pulses, nuts, oil seeds, spices, dry fruits, dehydrated vegetables, herbs and grasses, flowers, fresh leafy vegetables, fresh and dehydrated fruits, meats including wet and dry chunks (moisture 5% to 90%), fresh and dehydrated fish, tea leaves, coffee pods & cocoa pods. The items missed in this list if whole/powdered agricultural products, aquaculture products, meat and meat products, animal and bird feeds and other formulations primarily comprising of agricultural mass or waste are all considered included in the above.

Further, the time required with conventional systems and techniques for decontamination of agricultural products with trioxygen gas is around 96 hours, which is not economically feasible and dislodging trioxygen gas or trioxygen gas's smell also becomes difficult due to such long decontamination hours. Also, organoleptic properties and nutritional properties of the conventionally treated products could deteriorate with such long exposure of trioxygen gas. Further, conventional systems are not effective at a commercial level and do not provide for safe removal of trioxygen waste, prevention of overheating and pressure buildup and use of lowest level of trioxygen gas. The decontamination should be safe, environment friendly, efficient, and cost effective.

The systems of the present subject matter decontaminate the products in significantly shorter time and are therefore economically feasible. Also, the products treated with the systems of the present subject matter do not retain the smell of trioxygen gas and the organoleptic properties and the nutritional properties of the products treated with the systems of the present subject matter are maintained. Further, the systems of the present subject matter are commercially effective and provide for safe removal of trioxygen gas, prevent overheating and pressure buildup, and use low levels of trioxygen gas, which make them friendly, efficient, and cost effective.

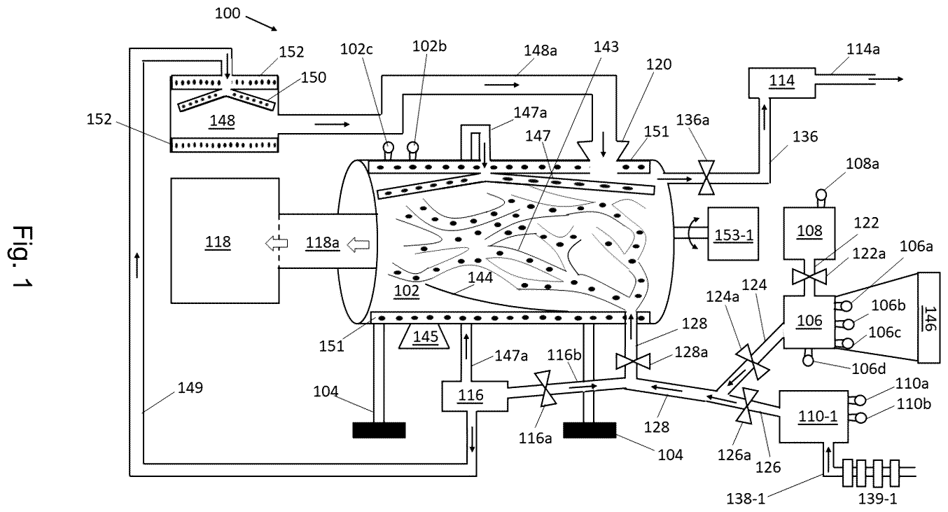

FIG. 1. illustrates a schematic representation of a system 100 for treatment of a product for decontamination of the product, in accordance with an example. The product and the decontaminants may be as described earlier in this disclosure. The system 100 includes a decontamination chamber 102 having an inlet 120 to receive a product which to be treated by the system 100. The decontamination chamber 102 may be a chamber of a cylindrical shape or any other suitable shape. The inlet 120 may be a hopper.

The system 100 includes multiple first channels 143 in the decontamination chamber 102. The multiple first channels 143 are distributed across the longitudinal span of the decontamination chamber 102. As shown in FIG. 1, the multiple first channels 143 may have channels in the form of tree-like branches, spanning across the longitudinal dimension of the decontamination chamber 102. Each of the multiple first channels 143 includes orifices that are of a size in a range of about 0.2 mm to about 90 mm. One or more of the orifices in the multiple first channels 143 have a mesh to control the product, being treated, from entering the orifices.

The system 100 also includes a trioxygen generator 106 with a feedline 128 coupled to the multiple first channels 143. The trioxygen generator 106, in its operational state, provides trioxygen gas to the multiple first channels 143 through the feedline 128 to disseminate trioxygen gas through the orifices in the multiple first channels 143 onto the product in the decontamination chamber 102. The system 100, as shown, includes an outlet 145 to output or draw out the trioxygen treated product.

Further, as shown, the system 100 includes an oxygen generator 108 with a pressure gauge 108a to monitor the pressure at which oxygen is generated in the oxygen generator 108. The trioxygen generator 106 is coupled to the oxygen generator 108 through an oxygen line 122 with a control valve 122a. The control valve 122a controls the rate at which oxygen is passed through the oxygen line 122 to the trioxygen generator 106. The trioxygen generator 106 receives oxygen from the oxygen generator 108 via the oxygen line 122. The trioxygen generator 106 generates trioxygen gas and provides trioxygen gas via trioxygen line 124 to the feedline 128 and from there to the decontamination chamber 102. The trioxygen line 124 has a control valve 124a to control the rate at which the trioxygen gas is passed there through. In an example, the feedline 128, the oxygen line 122, and the trioxygen line 124 may be silicon tubes.

Further, as shown in FIG. 1, the trioxygen generator 106 is provided with a pressure gauge 106a, an ammeter 106b, a flow meter 106c, and a current control switch 106d. The pressure gauge 106a monitors the pressure inside the trioxygen generator 106. The current control switch 106d controls the supply of current and the ammeter 106b monitors the current supplied to the trioxygen generator 106 for generation of trioxygen gas. The flow meter 106c monitors the flow rate at which oxygen is received inside the trioxygen generator 106 and also monitors the flow rate at which trioxygen is expelled out from the trioxygen generator 106 to the trioxygen line 124. The trioxygen generator 106 is also coupled with a chiller 146 to control the temperature of the trioxygen generator 106 while it is operating to generate trioxygen gas.

Further, as shown in FIG. 1, the system 100 comprises a liquid disseminator 116 that holds a pre-conditioning liquid. The pre-conditioning liquid may include, but is not limited to, H₂O₂ or HOCl or H₂O or citric acid or sodium bi-carbonate or a combination thereof. The system 100 includes at least one second channel 151 lined inside the decontamination chamber 102 along a longitudinal dimension of the decontamination chamber 102. The system 100, in FIG. 1, shows two second channels 151. The at least one second channel 151 has orifices and is coupled to the liquid disseminator 116 via a line 147a to receive the pre-conditioning liquid and disseminate the pre-conditioning liquid onto the product via the orifices. The orifices of the at least one second channel are of a size in a range of about 0.1 mm to about 50 mm. The orifices of the at least one second channel may or may not have meshes. In an example, one or more of the orifices of the at least one second channel have a mesh to control the product, being treated, from entering the orifices.

In an example, the at least one second channel 151 is coupled to the feedline 128 to disseminate the trioxygen gas onto the product in the decontamination chamber 102.

In an example, the system 100 optionally includes a spinning liquid disseminator 147. The spinning liquid disseminator 147 is coupled to the liquid disseminator 116 via the line 147a. The spinning liquid disseminator 147 is operated to spin and disseminate the pre-conditioning liquid onto the product inside the decontamination chamber 102.

Further, the system 100 comprises a hot air compressor 110-1 coupled to the feedline 128 via a hot air line 126. The hot air compressor 110-1 is operated to provide hot air to the product in the decontamination chamber 102 via the orifices of the multiple first channels. The hot air line 126 has a control valve 126a to control the flow rate of the hot air provided from the hot air compressor 110-1 to the decontamination chamber 102 via the feedline 128. The hot air compressor 110-1 comprises an air inlet 138-1 coupled to one or more air filters 139-1. The hot air compressor 110-1 is configured to receive air via the air inlet 138-1 which draws filtered air via the one or more air filters 139-1 and to provide hot air to the decontamination chamber 102. The one or more air filters are a HEPA filter (4/7) varying in micron size from 500 to 0.2 in series. The hot air compressor 110-1 is provided with a pressure gauge 110a and a temperature gauge 110b. The pressure gauge 110a is to monitor pressure of hot air in the hot air compressor 110-1 and the temperature gauge 110b is to monitor the temperature of the hot air. Alternatively, a cold air compressor can be connected to a heater with a temperature gauge to adjust the required temperature.

In an example, the liquid disseminator 116 is coupled to the feedline 128 via a line 116b to disseminate the pre-conditioning liquid through the orifices in the multiple first channels 143. The line 116b has a control valve 116a to control the flow rate of the pre-conditioning liquid to the feedline 128 and into the decontamination chamber 102 through the multiple first channels 143.

Further, as shown, the feedline 128 also has a control valve 128a to control the flow rate of the trioxygen gas from the trioxygen generator 106, the hot air from the hot air compressor 110-1, and the pre-conditioning liquid from the liquid disseminator 116.

Further, the system 100 includes a trioxygen destructor 114 coupled to the decontamination chamber 102 via an unused trioxygen line 136. The unused trioxygen gas in the decontamination chamber 102 is supplied to the trioxygen destructor 114 for converting the trioxygen gas back to oxygen and release the oxygen from the trioxygen destructor 114 through an output line 114a. The unused trioxygen line 136 includes a control valve 136a to control the flow rate of the unused trioxygen gas that is supplied to the trioxygen destructor 114.

In an example, the system 100 comprises a gear box 153-1 coupled to the decontamination chamber 102. The gear box 153-1 is to rotate the decontamination chamber 102 for movement of the product inside the decontamination chamber 102. The gear box 153-1 may be configured to rotate the decontamination chamber 102 at a constant or variable rotations per minute. The decontamination chamber 102 may be intermittently rotated by the gear box 153-1.

Further, in an example, the system 100 comprises one or more baffles 144 inside the decontamination chamber 102 for movement of the product inside the decontamination chamber 102. The one or more baffles 144 assist in homogenous exposure of the product from all of its surfaces to the trioxygen gas and/or pre-conditioning liquid disseminated inside the decontamination chamber 102 during the rotation of the decontamination chamber 102.

The decontamination chamber 102 is provided with a temperature gauge 102b to monitor temperature in the decontamination chamber 102. In an example, the decontamination chamber 102 is provided with a pressure gauge 102c to monitor pressure in the decontamination chamber 102. Further, the decontamination chamber 102 may be mounted on a mounting stand 104.

In order to maintain desired temperature and pressure in the system 100, the pressure gauges 102c, 106a, 108a, 110a and the temperature gauges 102b, 110b are disposed in the system 100 to operate the control valves 122a in the oxygen line 122, the control valve 124a in trioxygen line 124, the control valve 126a in the hot air line 126, the control valve 128a in the feedline line 128, and the control valve 136a in the unused trioxygen line 136.

In an example, the system 100 comprises a pre-conditioning chamber 148 coupled to the inlet 120 through a feedline 148a. The pre-conditioning chamber 148 comprises one or more channels 152 lined inside therein. The one or more channels 152 are coupled to the liquid disseminator 116 through a line 149. A raw product is added to the pre-conditioning chamber 148 and the pre-conditioning liquid is disseminated onto the raw product in the pre-conditioning chamber 148. The pre-conditioned product is then fed from the pre-conditioning chamber 148 to the decontamination chamber 102 via the feedline 148a and the inlet 120. The pre-conditioned product is then exposed to trioxygen gas in the decontamination chamber 102, where the trioxygen gas is disseminated through the orifices of the multiple first channels 143. In an example, the pre-conditioning chamber 148 includes a spinning liquid disseminator 150 coupled to the decontamination chamber 116 via the line 149. The spinning liquid disseminator 150 is operated to spin and disseminate the pre-conditioning liquid onto the raw product inside the pre-conditioning chamber 148.

Further, in an example, the system 100 includes a dry-heat exposure chamber 118 configured to receive the treated product from the decontamination chamber 102 via a conveyor mean 118. The conveyor means 118a is operated after the product is adequate treated with the trioxygen gas and/or the pre-conditioning liquid inside the decontamination chamber 102. The treated product received by the dry-heat exposure chamber 118 dries the product by a dry heat process.

In an example, the multiple first channels 143 inside the decontamination chamber 102 are rotated while disseminating the trioxygen gas and/or pre-conditioning liquid to uniformly distribute the trioxygen gas and/or pre-conditioning liquid onto the product inside the decontamination chamber 102.

In an example, any feedline or line described herein may be silicon tubes. In an example, any control valve described herein may be made of plastic or any other commonly known material.

Further, no vacuum is required to remove air, prior to introducing trioxygen gas to the decontamination chamber 102.

The description hereinafter describes an exemplary working of the system 100 of FIG. 1. At first, a raw and contaminated product is added into the decontamination chamber 102 through the inlet 120. Then, a pre-conditioning liquid is disseminated onto the product through the second channel(s) 151, lined inside the decontamination chamber 102, for a first predefined time period in a range of 1 min to 120 mins and at a flow rate of 1 liter/min (lpm) to 100 lpm. In one example, the pre-conditioning liquid can be solely or in combination disseminated through the multiple first channels 143. In another example, the product may be pre-treated by the pre-conditioning liquid, for example, in the pre-conditioning chamber 148 prior to adding it into the decontamination chamber 102. 3. In an example, while the pre-conditioning liquid is disseminated onto the product, the decontamination chamber 102 and/or the multiple first channels 143 may be rotated to rotate the product for uniform and homogenous exposure or mixing of the pre-conditioning liquid with the product. The baffles 144 inside the decontamination chamber may also help in rotation of the product and uniform and homogenous mixing of the pre-conditioning liquid with the product. After this, the trioxygen gas is disseminated onto the product through the multiple first channels 143 for a second predefined time period in a range of 10 seconds to 30 mins. In one example, the trioxygen gas may be disseminated at a flow rate in a range of 50 lpm to 100 lpm and at a concentration in a range of 0.01 g/kg to 10 g/kg In an example, while the trioxygen gas is disseminated onto the product, the decontamination chamber 102 and/or the multiple first channels 143 may be rotated to rotate the product for uniform and homogenous exposure or mixing of the trioxygen gas with the product. The baffles 144 inside the decontamination chamber 102 may also help in rotation of the product and uniform and homogenous mixing of the trioxygen gas with the product. In an example, the pre-conditioning liquid and the trioxygen gas together or individually may be disseminated in multiple cycles (e.g., 10 to 36 times). After that, the unused trioxygen gas in the decontamination chamber 102 is removed through the line 136 and converted back into oxygen by the trioxygen destructor 114. After exposing the product to trioxygen gas, hot air is passed from the hot air compressor 110 into the decontamination chamber 102 for heat drying the product. The hot air is passed with a flow rate in a range of 10 lpm to 100 lpm, at a temperature in a range of 45° C. to 75° C. and for a third pre-defined time period in a range of 10 mins to 60 mins. In an example, the trioxygen treated product may be taken out from the decontamination chamber 102 and heat dried outside the decontamination chamber 102, for example, in the dry-heat exposure chamber 118. After heat drying, the resultant product which is free of undesirable contaminants is taken out from the decontamination chamber 102. The product may be outputted from the outlet 145 or through the conveyor means 118a.

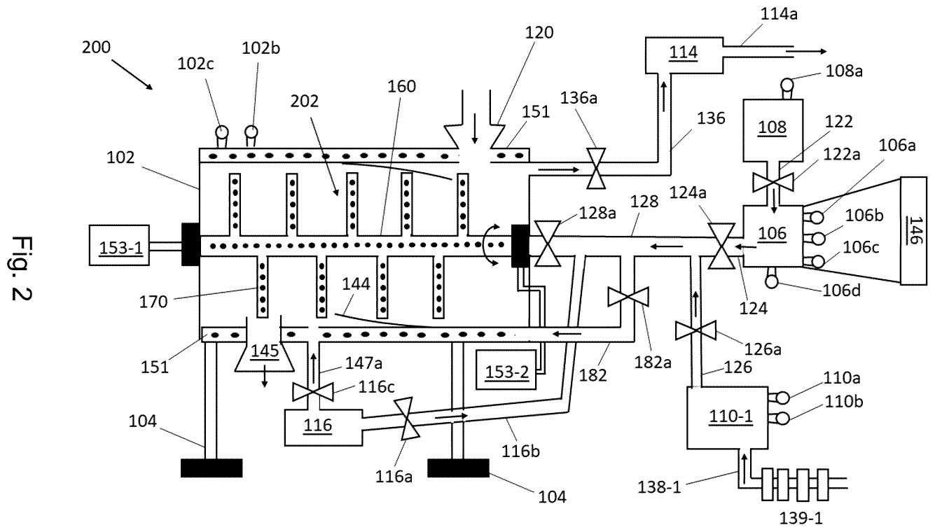

FIG. 2. illustrates a schematic representation of a system 200 for treatment of a product for decontamination of the product, in accordance with an example. The product and decontaminants may be as described earlier in this disclosure. The system 200 includes a decontamination chamber 102, similar to that of the system 100, having an inlet 120 to receive a product which to be treated by the system 200. The inlet 120 may be a hopper.

The system 200 includes multiple first channels 202 in the decontamination chamber 102. The multiple first channels 202 are distributed across the longitudinal span of the decontamination chamber 102. The multiple first channels 202 comprise: a longitudinal channel 160 coupled to a feedline 128 and having orifices to disseminate trioxygen gas onto the product in the decontamination chamber 102; and a set of sub-channels 170 coupled to the longitudinal channel 160 and having orifices to disseminate trioxygen gas onto the product in the decontamination chamber 102. Each sub-channel of the set of sub-channels 170 subtends an angle of about 90° with respect to the longitudinal channel 160. The orifices of the longitudinal channel 160 and of each channel of the set of sub-channels 170 are of a size in a range of about 0.2 mm to about 90 mm. One or more of these orifices have a mesh to control the product, being treated, from entering the orifices. In an example, the longitudinal channel 160 has a cross-sectional dimension in a range of about 10 cm to about 50 cm.

The system 200 also includes a trioxygen generator 106, similar to that of the system 100, with the feedline 128 coupled to the longitudinal channel 160. The trioxygen generator 106, in its operational state, provides trioxygen gas to the longitudinal channel and the set of sub-channels 170 through the feedline 128 to disseminate trioxygen gas through the orifices thereof onto the product in the decontamination chamber 102. The system 200, as shown, includes an outlet 145 to output or draw out the trioxygen treated product.

Further, as shown, the system 200 includes an oxygen generator 108 with a pressure gauge 108a, similar to that of system 100. The trioxygen generator 106 is coupled to the oxygen generator 108 through an oxygen line 122 with a control valve 122a. The control valve 122a controls the rate at which oxygen is passed through the oxygen line 122 to the trioxygen generator 106. The trioxygen generator 106 receives oxygen from the oxygen generator 108 via the oxygen line 122. The trioxygen generator 106 generates trioxygen gas and provides trioxygen gas via trioxygen line 124 to the feedline 128 and from there to the decontamination chamber 102. The trioxygen line 124 has a control valve 124a to control the rate at which the trioxygen gas is passed therethrough. In an example, the feedline 128, the oxygen line 122, and the trioxygen line 124 may be silicon tubes.

Further, as shown in FIG. 2, the trioxygen generator 106 is provided with a pressure gauge 106a, an ammeter 106b, a flow meter 106c, and a current control switch 106d, each of which perform respective functionality as described with respect to the system 100. The trioxygen generator 106 is also coupled with a chiller 146 to control the temperature of the trioxygen generator 106 while it is operating to generate trioxygen gas.

Further, as shown in FIG. 2, the system 200 comprises a liquid disseminator 116 that holds a pre-conditioning liquid. The pre-conditioning liquid may include, but is not limited to, H₂O₂ or HOCl or H₂O or citric acid or sodium bi-carbonate or a combination thereof. The system 200 includes at least one second channel 151 lined inside the decontamination chamber 102 along a longitudinal dimension of the decontamination chamber 102. The system 200, in FIG. 2, shows two second channels 151. The at least one second channel 151 has orifices and is coupled to the liquid disseminator 116 via a line 147a to receive the pre-conditioning liquid and disseminate the pre-conditioning liquid onto the product via the orifices. The line 147a has a control valve 116c to control the flow rate of the pre-conditioning liquid. The orifices of the at least one second channel are of a size in a range of about 0.1 mm to about 50 mm. The orifices of the at least one second channel may or may not have meshes. In an example, one or more of the orifices of the at least one second channel have a mesh to control the product, being treated, from entering the orifices.

In an example, the at least one second channel 151 is coupled to the feedline 128 to disseminate the trioxygen gas onto the product in the decontamination chamber 102. As shown, the second channel 151 is coupled to the feedline 128 via a line 182 having a control valve 182a.

Further, the system 200 comprises a hot air compressor 110-1 coupled to the feedline 128 via a hot air line 126. The hot air compressor 110-1 is operated to provide hot air to the product in the decontamination chamber 102 via the orifices of the longitudinal channel 160 and the set of sub-channels 170. The hot air line 126 has a control valve 126a to control the flow rate of the hot air provided from the hot air compressor 110-1 to the decontamination chamber 102 via the feedline 128. The hot air compressor 110-1 comprises an air inlet 138-1 coupled to one or more air filters 139-1. The hot air compressor 110-1 is configured to receive air via the air inlet 138-1 which draws filtered air via the one or more air filters 139-1 and to provide hot air to the decontamination chamber 102. The one or more air filters are a HEPA filter (4/7) varying in micron size from 500 to 0.2 in series.

The hot air compressor 110-1 is provided with a pressure gauge 110a and a temperature gauge 110b. The pressure gauge 110a is to monitor pressure of hot air in the hot air compressor 110-1 and the temperature gauge 110b is to monitor the temperature of the hot air. Alternatively, a cold air compressor can be connected to a heater with a temperature gauge to adjust the required temperature.

In an example, the longitudinal channel 160 is coupled to the liquid disseminator 116 to receive the pre-conditioning liquid and disseminate the pre-conditioning liquid onto the product via the orifices of the longitudinal channel 160 and of the set of sub-channels 170. As shown in FIG. 2, the liquid disseminator 116 is coupled to the feedline 128 and hence to the longitudinal channel 160 via a line 116b. The line 116b has a control valve 116a to control the flow rate of the pre-conditioning liquid to the feedline 128 and into the decontamination chamber 102.

Further, as shown in FIG. 2, the feedline 128 also has a control valve 128a to control the flow rate of the trioxygen gas from the trioxygen generator 106, the hot air from the hot air compressor 110-1, and the pre-conditioning liquid from the liquid disseminator 116.

Further, the system 200 includes a trioxygen destructor 114 coupled to the decontamination chamber 102 via an unused trioxygen line 136. The unused trioxygen gas in the decontamination chamber 102 is supplied to the trioxygen destructor 114 for converting the trioxygen gas back to oxygen and release the oxygen from the trioxygen destructor 114 through an output line 114a. The unused trioxygen line 136 includes a control valve 136a to control the flow rate of the unused trioxygen gas that is supplied to the trioxygen destructor 114.

In an example, the system 200 comprises a gear box 153-2 coupled to the feedline 128 and the longitudinal channel 160. The gear box 153-2 is to rotate the longitudinal channel 160 and the set of sub-channels 170 for movement of the product inside the decontamination chamber 102. The gear box 153-2 may be configured to rotate the longitudinal channel 160 at a constant or variable rotations per minute. The longitudinal channel 160 may be intermittently rotated by the gear box 153-2.

the system comprises:

In an example, the system 200 also includes a gear box 153-1 coupled to the decontamination chamber 102. The gear box 153-1 is to rotate the decontamination chamber 102 for movement of the product inside the decontamination chamber 102.

Further, the system 200 comprises one or more baffles 144 inside the decontamination chamber 102 for movement of the product inside the decontamination chamber 102. The one or more baffles 144 assist in homogenous exposure of the product from all of its surfaces to the trioxygen gas and/or pre-conditioning liquid disseminated inside the decontamination chamber 102 during the rotation of the decontamination chamber 102.

The decontamination chamber 102 is provided with a temperature gauge 102b to monitor temperature in the decontamination chamber 102. The decontamination chamber 102 is also provided with a pressure gauge 102c to monitor pressure in the decontamination chamber 102. Further, the decontamination chamber 102 may be mounted on a mounting stand 104.

In order to maintain desired temperature and pressure in the system 200, the pressure gauges 102c, 106a, 108a, 110a and the temperature gauges 102b, 110b are disposed in the system 200 to operate the control valves 122a in the oxygen line 122, the control valve 124a in trioxygen line 124, the control valve 126a in the hot air line 126, the control valve 128a in the feedline line 128, and the control valve 136a in the unused trioxygen line 136.

In an example, any feedline or line described herein may be silicon tubes. In an example, any control valve described herein may be made of plastic, metal, or any other commonly known material.

Further, no vacuum is required to remove air, prior to introducing trioxygen gas to the decontamination chamber 102.

The description hereinafter describes an exemplary working of the system 200 of FIG. 2. At first, raw and contaminated product is added into the decontamination chamber 102 through the inlet 120. Then, a pre-conditioning liquid is disseminated onto the product through the second channel(s) 151, lined inside the decontamination chamber 102, for a first predefined time period in a range of 1 min to 120 mins and at a flow rate of 1 lpm to 100 lpm. In one example, the pre-conditioning liquid can be disseminated through the longitudinal channel 170 and the set of sub-channels 170. In another examples, the product may be treated by the pre-conditioning liquid prior to adding it into the decontamination chamber 102. In an example, while the pre-conditioning liquid is disseminated onto the product, the decontamination chamber 102 and/or the longitudinal channel 160 and the set of sub-channels 170 may be rotated to rotate the product for uniform and homogenous exposure or mixing of the pre-conditioning liquid with the product. The baffle(s) 144 inside the decontamination chamber 102 may also help in rotation of the product and uniform and homogenous mixing of the pre-conditioning liquid with the product. After this, trioxygen gas is disseminated onto the product through the longitudinal channel 160 and the set of sub-channels 170 for a second predefined time period in a range of 10 seconds to 30 mins. In one example, the trioxygen gas may be disseminated at a flow rate in a range of 50 lpm to 100 lpm and at a concentration in a range of 0.01 g/kg to 10 g/kg. In an example, while the trioxygen gas is disseminated onto the product, the decontamination chamber 102 and/or the longitudinal channel 160 and the set of sub-channels 170 may be rotated to rotate the product for uniform and homogenous exposure or mixing of the trioxygen gas with the product. The baffle(s) 144 inside the decontamination chamber may also help in rotation of the product and uniform and homogenous mixing of the trioxygen gas with the product. The dissemination of the trioxygen gas and the pre-conditioning liquid together or individually may be repeated multiple times. The unused trioxygen gas in the decontamination chamber is then removed through the line 136 and converted back into oxygen by the trioxygen destructor 114. After exposing the product to trioxygen gas, hot air is passed from the hot air compressor 110-1 into the decontamination chamber for heat drying the product. The hot air is passed with a flow rate in a range of 10 lpm to 100 lpm, at a temperature in a range of 45° C. to 75° C. and for a third pre-defined time period in a range of 10 mins to 60 mins. In an example, the trioxygen treated product may be taken out from the decontamination chamber 102 and heat dried outside the decontamination chamber 102. After heat drying, the resultant product which is free of undesirable contaminants is taken out from the decontamination chamber 102 via the outlet 145.

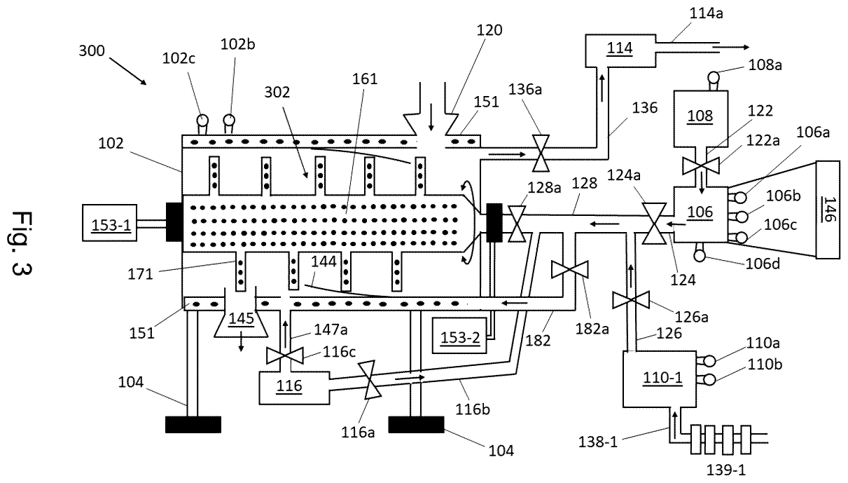

FIG. 3. illustrates a schematic representation of a system 300 for treatment of a product for decontamination of the product, in accordance with an example. The product and decontaminants may be as described earlier in this disclosure. The system 300 includes a decontamination chamber 102, similar to that of the system 100, having an inlet 120 to receive a product which to be treated by the system 300. The inlet 120 may be a hopper.

The system 300 includes multiple first channels 302 in the decontamination chamber 102. The multiple first channels 302 are distributed across the longitudinal span of the decontamination chamber 102. The multiple first channels 302 comprise: a longitudinal channel 161 coupled to a feedline 128 and having orifices to disseminate trioxygen gas onto the product in the decontamination chamber 102; and a set of sub-channels 171 coupled to the longitudinal channel 161 and having orifices to disseminate trioxygen gas onto the product in the decontamination chamber 102. Each sub-channel of the set of sub-channels 171 subtends an angle of about 90° with respect to the longitudinal channel 161. The orifices of the longitudinal channel 161 and of each channel of the set of sub-channels 171 are of a size in a range of about 0.2 mm to about 90 mm. One or more of these orifices have a mesh to control the product, being treated, from entering the orifices. As shown in FIG. 3, the longitudinal channel 161 is wider than the longitudinal channel 160 of the system 200. In an example, the longitudinal channel 161 has a cross-sectional dimension in a range of about 30 cm to about 50 cm.

In an example, apart from the difference in the configuration of the multiple first channels 302, the components of the system 300 and their configuration and functioning is similar to those of the system 200 as described above.

The system 300 also includes a trioxygen generator 106, similar to that of the system 100, with the feedline 128 coupled to the longitudinal channel 161. The trioxygen generator 106, in its operational state, provides trioxygen gas to the longitudinal channel 161 and the set of sub-channels 171 through the feedline 128 to disseminate trioxygen gas through the orifices thereof onto the product in the decontamination chamber 102. The system 300, as shown, includes an outlet 145 to output or draw out the trioxygen treated product.

Further, as shown, the system 300 includes an oxygen generator 108 with a pressure gauge 108a, similar to that of system 100. The trioxygen generator 106 is coupled to the oxygen generator 108 through an oxygen line 122 with a control valve 122a. The control valve 122a controls the rate at which oxygen is passed through the oxygen line 122 to the trioxygen generator 106. The trioxygen generator 106 receives oxygen from the oxygen generator 108 via the oxygen line 122. The trioxygen generator 106 generates trioxygen gas and provides trioxygen gas via trioxygen line 124 to the feedline 128 and from there to the decontamination chamber 102. The trioxygen line 124 has a control valve 124a to control the rate at which the trioxygen gas is passed therethrough. In an example, the feedline 128, the oxygen line 122, and the trioxygen line 124 may be silicon tubes.

Further, as shown in FIG. 3, the trioxygen generator 106 is provided with a pressure gauge 106a, an ammeter 106b, a flow meter 106c, and a current control switch 106d, each of which perform respective functionality as described with respect to the system 100. The trioxygen generator 106 is also coupled with a chiller 146 to control the temperature of the trioxygen generator 106 while it is operating to generate trioxygen gas.

Further, as shown in FIG. 3, the system 300 comprises a liquid disseminator 116 that holds a pre-conditioning liquid. The pre-conditioning liquid may include, but is not limited to, H₂O₂ or HOCl or H₂O or citric acid or sodium bi-carbonate or a combination thereof. The system 300 includes at least one second channel 151 lined inside the decontamination chamber 102 along a longitudinal dimension of the decontamination chamber 102. The system 300, in FIG. 3, shows two second channels 151. The at least one second channel 151 has orifices and is coupled to the liquid disseminator 116 via a line 147a to receive the pre-conditioning liquid and disseminate the pre-conditioning liquid onto the product via the orifices. The line 147a has a control valve 116c to control the flow rate of the pre-conditioning liquid. The orifices of the at least one second channel are of a size in a range of about 0.1 mm to about 50 mm. The orifices of the at least one second channel may or may not have meshes. In an example, one or more of the orifices of the at least one second channel have a mesh to control the product, being treated, from entering the orifices.

In an example, the at least one second channel 151 is coupled to the feedline 128 to disseminate the trioxygen gas onto the product in the decontamination chamber 102. As shown, the second channel 151 is coupled to the feedline 128 via a line 182 having a control valve 182a.

Further, the system 300 comprises a hot air compressor 110-1 coupled to the feedline 128 via a hot air line 126. The hot air compressor 110-1 is operated to provide hot air to the product in the decontamination chamber 102 via the orifices of the longitudinal channel 161 and the set of sub-channels 171. The hot air line 126 has a control valve 126a to control the flow rate of the hot air provided from the hot air compressor 110-1 to the decontamination chamber 102 via the feedline 128. The hot air compressor 110-1 comprises an air inlet 138-1 coupled to one or more air filters 139-1. The hot air compressor 110-1 is configured to receive air via the air inlet 138-1 which draws filtered air via the one or more air filters 139-1 and to provide hot air to the decontamination chamber 102. The one or more air filters are a HEPA filter (4/7) varying in micron size from 500 to 0.2 in series. The hot air compressor 110-1 is provided with a pressure gauge 110a and a temperature gauge 110b. The pressure gauge 110a is to monitor pressure of hot air in the hot air compressor 110-1 and the temperature gauge 110b is to monitor the temperature of the hot air. Alternatively, a cold air compressor can be connected to a heater with a temperature gauge to adjust the required temperature.

In an example, the longitudinal channel 161 is coupled to the liquid disseminator 116 to receive the pre-conditioning liquid and disseminate the pre-conditioning liquid onto the product via the orifices of the longitudinal channel 161 and of the set of sub-channels 171. As shown in FIG. 3, the liquid disseminator 116 is coupled to the feedline 128 and hence to the longitudinal channel 161 via a line 116b. The line 116b has a control valve 116a to control the flow rate of the pre-conditioning liquid to the feedline 128 and into the decontamination chamber 102.

Further, as shown in FIG. 3, the feedline 128 also has a control valve 128a to control the flow rate of the trioxygen gas from the trioxygen generator 106, the hot air from the hot air compressor 110-1, and the pre-conditioning liquid from the liquid disseminator 116.

Further, the system 300 includes a trioxygen destructor 114 coupled to the decontamination chamber 102 via an unused trioxygen line 136. The unused trioxygen gas in the decontamination chamber 102 is supplied to the trioxygen destructor 114 for converting the trioxygen gas back to oxygen and release the oxygen from the trioxygen destructor 114 through an output line 114a. The unused trioxygen line 136 includes a control valve 136a to control the flow rate of the unused trioxygen gas that is supplied to the trioxygen destructor 114.

In an example, the system 300 comprises a gear box 153-2 coupled to the feedline 128 and the longitudinal channel 161. The gear box 153-2 is to rotate the longitudinal channel 161 and the set of sub-channels 171 for movement of the product inside the decontamination chamber 102. The gear box 153-2 may be configured to rotate the longitudinal channel 161 at a constant or variable rotations per minute. The longitudinal channel 161 may be intermittently rotated by the gear box 153-2.

In an example, the system 300 also includes a gear box 153-1 coupled to the decontamination chamber 102. The gear box 153-1 is to rotate the decontamination chamber 102 for movement of the product inside the decontamination chamber 102.

Further, the system 300 comprises one or more baffles 144 inside the decontamination chamber 102 for movement of the product inside the decontamination chamber 102. The one or more baffles 144 assist in homogenous exposure of the product from all of its surfaces to the trioxygen gas and/or pre-conditioning liquid disseminated inside the decontamination chamber 102 during the rotation of the decontamination chamber 102.

The decontamination chamber 102 is provided with a temperature gauge 102b to monitor temperature in the decontamination chamber 102. The decontamination chamber 102 is also provided with a pressure gauge 102c to monitor pressure in the decontamination chamber 102. Further, the decontamination chamber 102 may be mounted on a mounting stand 104.

In order to maintain desired temperature and pressure in the system 300, the pressure gauges 102c, 106a, 108a, 110a and the temperature gauges 102b, 110b are disposed in the system 300 to operate the control valves 122a in the oxygen line 122, the control valve 124a in trioxygen line 124, the control valve 126a in the hot air line 126, the control valve 128a in the feedline line 128, and the control valve 136a in the unused trioxygen line 136.

In an example, any feedline or line described herein may be silicon tubes. In an example, any control valve described herein may be made of plastic, metal, or any other commonly known material.

Further, no vacuum is required to remove air, prior to introducing trioxygen gas to the decontamination chamber 102.

The description hereinafter describes an exemplary working of the system 300 of FIG. 3. At first, raw and contaminated product is added into the decontamination chamber 102 through the inlet 120. Then, a pre-conditioning liquid is disseminated onto the product through the second channel(s) 151, lined inside the decontamination chamber 102, for a first predefined time period in a range of 1 min to 120 mins and at a flow rate of 1 lpm to 100 lpm. In one example, the pre-conditioning liquid can be disseminated through the longitudinal channel 161 and the set of sub-channels 171. In another examples, the product may be treated by the pre-conditioning liquid prior to adding it into the decontamination chamber 102.

In an example, while the pre-conditioning liquid is disseminated onto the product, the decontamination chamber 102 and/or the longitudinal channel 161 and the set of sub-channels 171 may be rotated to rotate the product for uniform and homogenous exposure or mixing of the pre-conditioning liquid with the product. The baffle(s) 144 inside the decontamination chamber 102 may also help in rotation of the product and uniform and homogenous mixing of the pre-conditioning liquid with the product. After this, trioxygen gas is disseminated onto the product through the longitudinal channel 161 and the set of sub-channels 171 for a second predefined time period in a range of 10 seconds to 30 mins. In one example, the trioxygen gas may be disseminated at a flow rate in a range of 50 lpm to 100 lpm and at a concentration in a range of 0.01 g/kg to 10 g/kg. In an example, while the trioxygen gas is disseminated onto the product, the decontamination chamber 102 and/or the longitudinal channel 161 and the set of sub-channels 171 may be rotated to rotate the product for uniform and homogenous exposure or mixing of the trioxygen gas with the product. The baffle(s) 144 inside the decontamination chamber may also help in rotation of the product and uniform and homogenous mixing of the trioxygen gas with the product. The dissemination of the trioxygen gas and the pre-conditioning liquid together or individually may be repeated multiple times. The unused trioxygen gas in the decontamination chamber is then removed through the line 136 and converted back into oxygen by the trioxygen destructor 114. After exposing the product to trioxygen gas, hot air is passed from the hot air compressor 110-1 into the decontamination chamber for heat drying the product. The hot air is passed with a flow rate in a range of 10 lpm to 100 lpm, at a temperature in a range of 45° C. to 75° C. and for a third pre-defined time period in a range of 10 mins to 60 mins. In an example, the trioxygen treated product may be taken out from the decontamination chamber 102 and heat dried outside the decontamination chamber 102. After heat drying, the resultant product which is free of undesirable contaminants is taken out from the decontamination chamber 102 via the outlet 145.

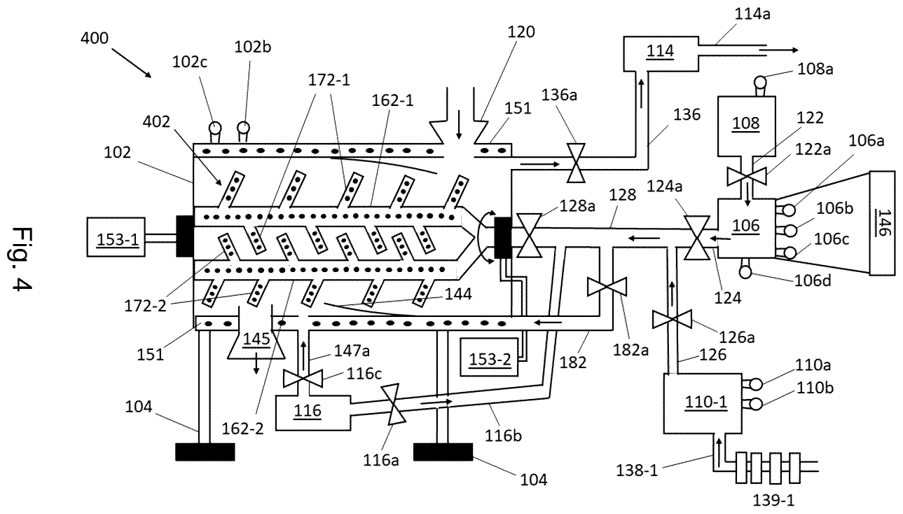

FIG. 4. illustrates a schematic representation of a system 400 for treatment of a product for decontamination of the product, in accordance with an example. The product and decontaminants may be as described earlier in this disclosure. The system 400 includes a decontamination chamber 102, similar to that of the system 100, having an inlet 120 to receive a product which to be treated by the system 400. The inlet 120 may be a hopper.

The system 400 includes multiple first channels 402 in the decontamination chamber 102. The multiple first channels 402 are distributed across the longitudinal span of the decontamination chamber 102. The multiple first channels 402 comprise: two longitudinal channels 162-1, 162-2 coupled to a feedline 128 and having orifices to disseminate trioxygen gas onto the product in the decontamination chamber 102; and a set of sub-channels 172-1, 172-2 coupled to the respective longitudinal channels 162-1, 162-2 and having orifices to disseminate trioxygen gas onto the product in the decontamination chamber 102. Each sub-channel of the set of sub-channels 172-1, 172-2 subtends an angle of in a range of about 30° to about 90° with respect to the respective longitudinal channels 162-1, 162-2. The orifices of the longitudinal channels 162-1, 162-2 and of each channel of the set of sub-channels 172-1, 172-2 are of a size in a range of about 0.2 mm to about 90 mm. One or more of these orifices may have a mesh to control the product, being treated, from entering the orifices. In an example, each of the two longitudinal channels 162-1, 162-2 has a cross-sectional dimension in a range of about 30 cm to about 50 cm.

In an example, apart from the difference in the configuration of the multiple first channels 402, the components of the system 300 and their configuration and functioning is similar to those of the system 200 as described above.

The system 400 includes a trioxygen generator 106, similar to that of the system 100, with the feedline 128 coupled to the longitudinal channel 161. The trioxygen generator 106, in its operational state, provides trioxygen gas to the longitudinal channels 162-1, 162-2 and the set of sub-channels 172-1, 172-2 through the feedline 128 to disseminate trioxygen gas through the orifices thereof onto the product in the decontamination chamber 102. The system 400, as shown, includes an outlet 145 to output or draw out the trioxygen treated product.

Further, as shown, the system 400 includes an oxygen generator 108 with a pressure gauge 108a, similar to that of system 100. The trioxygen generator 106 is coupled to the oxygen generator 108 through an oxygen line 122 with a control valve 122a. The control valve 122a controls the rate at which oxygen is passed through the oxygen line 122 to the trioxygen generator 106. The trioxygen generator 106 receives oxygen from the oxygen generator 108 via the oxygen line 122. The trioxygen generator 106 generates trioxygen gas and provides trioxygen gas via trioxygen line 124 to the feedline 128 and from there to the decontamination chamber 102. The trioxygen line 124 has a control valve 124a to control the rate at which the trioxygen gas is passed therethrough. In an example, the feedline 128, the oxygen line 122, and the trioxygen line 124 may be silicon tubes.

Further, as shown in FIG. 4, the trioxygen generator 106 is provided with a pressure gauge 106a, an ammeter 106b, a flow meter 106c, and a current control switch 106d, each of which perform respective functionality as described with respect to the system 100. The trioxygen generator 106 is also coupled with a chiller 146 to control the temperature of the trioxygen generator 106 while it is operating to generate trioxygen gas.

Further, as shown in FIG. 4, the system 400 comprises a liquid disseminator 116 that holds a pre-conditioning liquid. The pre-conditioning liquid may include, but is not limited to, H₂O₂ or HOCl or H₂O or citric acid or sodium bi-carbonate or a combination thereof. The system 400 includes at least one second channel 151 lined inside the decontamination chamber 102 along a longitudinal dimension of the decontamination chamber 102. The system 400, in FIG. 4, shows two second channels 151. The at least one second channel 151 has orifices and is coupled to the liquid disseminator 116 via a line 147a to receive the pre-conditioning liquid and disseminate the pre-conditioning liquid onto the product via the orifices. The line 147a has a control valve 116c to control the flow rate of the pre-conditioning liquid. The orifices of the at least one second channel are of a size in a range of about 0.1 mm to about 50 mm. The orifices of the at least one second channel may or may not have meshes. In an example, one or more of the orifices of the at least one second channel have a mesh to control the product, being treated, from entering the orifices.

In an example, the at least one second channel 151 is coupled to the feedline 128 to disseminate the trioxygen gas onto the product in the decontamination chamber 102. As shown, the second channel 151 is coupled to the feedline 128 via a line 182 having a control valve 182a.

Further, the system 400 comprises a hot air compressor 110-1 coupled to the feedline 128 via a hot air line 126. The hot air compressor 110-1 is operated to provide hot air to the product in the decontamination chamber 102 via the orifices of the longitudinal channels 162-1, 162-2 and the set of sub-channels 172-1, 172-2. The hot air line 126 has a control valve 126a to control the flow rate of the hot air provided from the hot air compressor 110-1 to the decontamination chamber 102 via the feedline 128. The hot air compressor 110-1 comprises an air inlet 138-1 coupled to one or more air filters 139-1. The hot air compressor 110-1 is configured to receive air via the air inlet 138-1 which draws filtered air via the one or more air filters 139-1 and to provide hot air to the decontamination chamber 102. The one or more air filters are a HEPA filter (4/7) varying in micron size from 500 to 0.2 in series. The hot air compressor 110-1 is provided with a pressure gauge 110a and a temperature gauge 110b. The pressure gauge 110a is to monitor pressure of hot air in the hot air compressor 110-1 and the temperature gauge 110b is to monitor the temperature of the hot air. Alternatively, a cold air compressor can be connected to a heater with a temperature gauge to adjust the required temperature.

In an example, the each of the longitudinal channels 162-1, 162-2 is coupled to the liquid disseminator 116 to receive the pre-conditioning liquid and disseminate the pre-conditioning liquid onto the product via the orifices of the longitudinal channels 162-1, 162-2 and of the set of sub-channels 172-1, 172-2. As shown in FIG. 4, the liquid disseminator 116 is coupled to the feedline 128 and hence to the longitudinal channels 162-1, 162-2 via a line 116b. The line 116b has a control valve 116a to control the flow rate of the pre-conditioning liquid to the feedline 128 and into the decontamination chamber 102.

Further, as shown in FIG. 4, the feedline 128 also has a control valve 128a to control the flow rate of the trioxygen gas from the trioxygen generator 106, the hot air from the hot air compressor 110-1, and the pre-conditioning liquid from the liquid disseminator 116.

Further, the system 400 includes a trioxygen destructor 114 coupled to the decontamination chamber 102 via an unused trioxygen line 136. The unused trioxygen gas in the decontamination chamber 102 is supplied to the trioxygen destructor 114 for converting the trioxygen gas back to oxygen and release the oxygen from the trioxygen destructor 114 through an output line 114a. The unused trioxygen line 136 includes a control valve 136a to control the flow rate of the unused trioxygen gas that is supplied to the trioxygen destructor 114.

In an example, the system 400 comprises a gear box 153-2 coupled to the feedline 128 and the longitudinal channels 162-1, 162-2. The gear box 153-2 is to rotate the longitudinal channels 162-1, 162-2 and the set of sub-channels 172-1, 172-2 for movement of the product inside the decontamination chamber 102. The gear box 153-2 may be configured to rotate the longitudinal channels 162-1, 162-2 at a constant or variable rotations per minute. The longitudinal channels 162-1, 162-2 may be intermittently rotated by the gear box 153-2.

In an example, the system 400 also includes a gear box 153-1 coupled to the decontamination chamber 102. The gear box 153-1 is to rotate the decontamination chamber 102 for movement of the product inside the decontamination chamber 102.

Further, the system 400 comprises one or more baffles 144 inside the decontamination chamber 102 for movement of the product inside the decontamination chamber 102. The one or more baffles 144 assist in homogenous exposure of the product from all of its surfaces to the trioxygen gas and/or pre-conditioning liquid disseminated inside the decontamination chamber 102 during the rotation of the decontamination chamber 102.

The decontamination chamber 102 is provided with a temperature gauge 102b to monitor temperature in the decontamination chamber 102. The decontamination chamber 102 is also provided with a pressure gauge 102c to monitor pressure in the decontamination chamber 102. Further, the decontamination chamber 102 may be mounted on a mounting stand 104.

In order to maintain desired temperature and pressure in the system 400, the pressure gauges 102c, 106a, 108a, 110a and the temperature gauges 102b, 110b are disposed in the system 400 to operate the control valves 122a in the oxygen line 122, the control valve 124a in trioxygen line 124, the control valve 126a in the hot air line 126, the control valve 128a in the feedline line 128, and the control valve 136a in the unused trioxygen line 136.

In an example, any feedline or line described herein may be silicon tubes. In an example, any control valve described herein may be made of plastic, metal, or any other commonly known material.

Further, no vacuum is required to remove air, prior to introducing trioxygen gas to the decontamination chamber 102.

The description hereinafter describes an exemplary working of the system 400 of FIG. 4. At first, raw and contaminated product is added into the decontamination chamber 102 through the inlet 120. Then, a pre-conditioning liquid is disseminated onto the product through the second channel(s) 151, lined inside the decontamination chamber 102, for a first predefined time period in a range of 1 min to 120 mins and at a flow rate of 1 lpm to 100 lpm. In one example, the pre-conditioning liquid can be disseminated through the longitudinal channels 162-1, 162-2 and the set of sub-channels 172-1, 162-2. In another examples, the product may be treated by the pre-conditioning liquid prior to adding it into the decontamination chamber 102. In an example, while the pre-conditioning liquid is disseminated onto the product, the decontamination chamber 102 and/or the longitudinal channel 162-1, 162-2 and the set of sub-channels 172-1, 172-2 may be rotated to rotate the product for uniform and homogenous exposure or mixing of the pre-conditioning liquid with the product. The baffle(s) 144 inside the decontamination chamber 102 may also help in rotation of the product and uniform and homogenous mixing of the pre-conditioning liquid with the product. After this, trioxygen gas is disseminated onto the product through the longitudinal channel 162-1, 162-2 and the set of sub-channels 172-1, 172-2 for a second predefined time period in a range of 10 seconds to 30 mins. In one example, the trioxygen gas may be disseminated at a flow rate in a range of 50 lpm to 100 lpm and at a concentration in a range of 0.01 g/kg to 10 g/kg. In an example, while the trioxygen gas is disseminated onto the product, the decontamination chamber 102 and/or the longitudinal channel 162-1, 162-2 and the set of sub-channels 172-1, 172-2 may be rotated to rotate the product for uniform and homogenous exposure or mixing of the trioxygen gas with the product. The baffle(s) 144 inside the decontamination chamber may also help in rotation of the product and uniform and homogenous mixing of the trioxygen gas with the product. The dissemination of the trioxygen gas and the pre-conditioning liquid together or individually may be repeated multiple times. The unused trioxygen gas in the decontamination chamber 102 is then removed through the line 136 and converted back into oxygen by the trioxygen destructor 114. After exposing the product to trioxygen gas, hot air is passed from the hot air compressor 110-1 into the decontamination chamber for heat drying the product. The hot air is passed with a flow rate in a range of 10 lpm to 100 lpm, at a temperature in a range of 45° C. to 75° C. and for a third pre-defined time period in a range of 10 mins to 60 mins. In an example, the trioxygen treated product may be taken out from the decontamination chamber 102 and heat dried outside the decontamination chamber 102. After heat drying, the resultant product which is free of undesirable contaminants is taken out from the decontamination chamber 102 via the outlet 145.

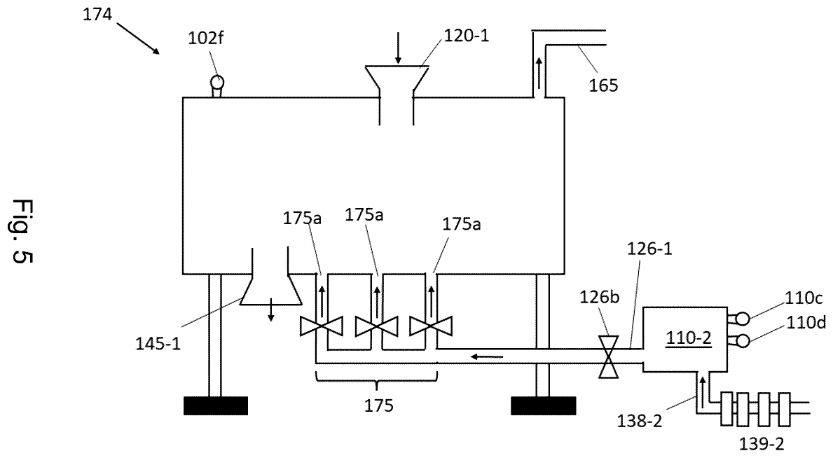

FIG. 5. illustrates an example schematic representation of a drying chamber 174 that can be optionally used with the systems 100, 200, 300, 400 of FIG. 1, FIG. 2, FIG. 3, FIG. 4 for treatment of a product for decontamination of the product, in accordance with an example. In an example, any of the systems 100, 200, 300, 400 of FIG. 1, FIG. 2, FIG. 3, FIG. 4 may comprise the drying chamber 174.

Accordingly, the system 100, 200, 300, 400 comprises the drying chamber 174 having an inlet 120-1 to receive the trioxygen and preconditioning liquid treated product from the decontamination chamber 102. The inlet 120-1 may be a hopper. In an example, the outlet 145 of the system 100, 200, 300, 400 may be coupled to the inlet 120-1 of the drying chamber through a product transfer line (not shown) or a conveyor means (not shown).

Further, the system 100, 200, 300, 400 may comprise a hot air compressor 110-2 coupled to the drying chamber 174 via one or more hot-air inlets 175a. The hot air compressor 110-2 may be similar to the hot air compressor 110-1 and is configured to provide hot air to the product in the drying chamber 174 via the one or more hot-air inlets 175a. The one or more hot air inlets 175a are coupled to the hot air compressor 110-2 through a manifold 175 and a line 126-1. The line 126-1 may have a control valve 126b to control the flow rate of the hot air from the hot compressor 110-2 to the drying chamber 174. The drying chamber 174 comprises an outlet 145-1 to output the hot-air dried product.

Further, as shown in FIG. 5, the hot air compressor 110-2 comprises an air inlet 138-2 coupled to one or more air-filters 139-2. The one or more air-filters 139-1 may be similar to the air-filter 139-1, as described earlier in this disclosure.

Further, as shown in FIG. 5, the hot air compressor 110-2 has a pressure gauge 110c and a temperature gauge 110d to monitor pressure and temperature, respectively, inside the hot air compressor 110-2.

Further, as shown in FIG. 5, the drying chamber 174 includes an exhaust line 165 for dispensing hot air for the drying chamber 174. The drying chamber also has a temperature gauge 102f to monitor the temperature inside the drying chamber.

In an example, the drying chamber 174 may be connected to a gear box (not shown) to rotate the drying chamber 174 while the hot air is passed into the drying chamber 174 for drying the product. The drying chamber 174 may be rotated intermittently and continuously during the drying procedure.

The description hereinafter describes an exemplary working of the drying chamber 174 of FIG. 5. At first, the trioxygen and preconditioning liquid treated product from the decontamination chamber 102 is added into the drying chamber 174 through the inlet 120-1 and hot air is passed from 110 into the drying chamber 174 for heat drying the product. The hot air is passed with a flow rate in a range of 10 lpm to 100 lpm, at a temperature in a range of 45° C. to 75° C. and for a third pre-defined time period in a range of 10 mins to 60 mins. After heat drying, the resultant heat-dried product which is free of undesirable contaminants is taken out from the drying chamber from the outlet 145-1.

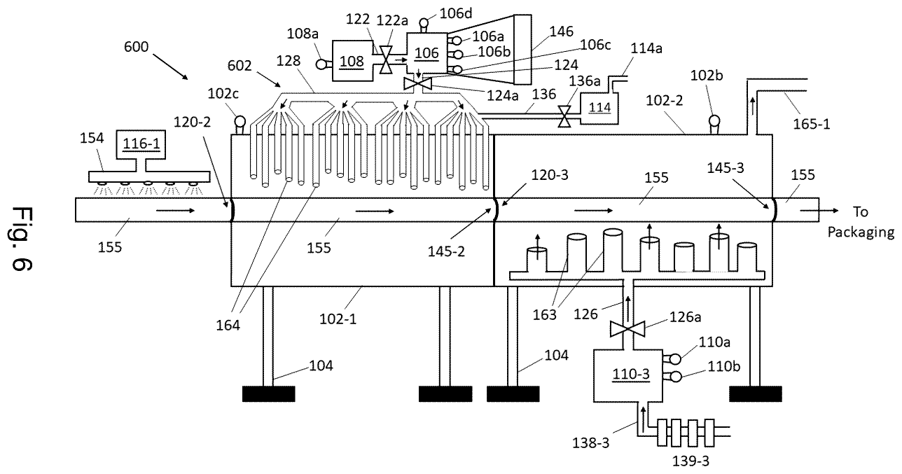

FIG. 6. illustrates a schematic representation of a system 600 for treatment of a product for decontamination of the product, in accordance with an example. The product and decontaminants may be as described earlier in this disclosure. The system 600 includes a decontamination chamber 102-1 having an inlet 120-2 to receive a product which to be treated by the system 600. The inlet 120-2 is an opening in the decontamination chamber 102-1 of a size just enough to pass a conveyor unit or conveyor means 155 therethrough.

The system 600 includes a trioxygen generator 106, similar to that of the system 100, with a feedline 128 through which trioxygen gas is provided into the decontamination chamber 102-1. The system 600 includes multiple first channels 602 in the decontamination chamber 102-1. The multiple first channels 602 are distributed across the longitudinal span of the decontamination chamber 102-1. The multiple first channels 602, as shown in FIG. 6, comprise pipes 164 extending from inside of the decontamination chamber 102-1 towards the outer surface of the decontamination chamber 102-1. One end of each of the pipes 164 is coupled to the feedline 128 from the trioxygen generator 106 and another end of the each of the pipes 164 is a free end inside the decontamination chamber 102-1 to disseminate trioxygen gas onto the product in the decontamination chamber 102-1. In an example, the pipes 164 have varying lengths inside the decontamination chamber 102-1. The lengths of the pipes may depend on the cross-sectional dimension of the decontamination chamber 102-1. In an example, each of the pipes 164 has a cross-sectional dimension in a range of about 1 cm to 30 cm.

In an example, as shown in FIG. 6, the feedline line 128 on one side is connected to the trioxygen generator 106 and on the other side may be a longitudinal channel with sub-channels branching out from the longitudinal channel and each of the sub-channels are coupled to a set of pipes 162 that are passing through and into the decontamination chamber 102-1. The trioxygen generator 106, in its operational state, provides trioxygen gas to the pipes 164 via the feedline 128 to disseminate trioxygen gas through the open ends of the pipes onto the product in the decontamination chamber 102-1.

The system 600, as shown, also includes an outlet 145-2 to output or draw out the trioxygen treated product from the decontamination chamber 102-1. Like the inlet 120-2, the outlet 145-2 is also an opening in the decontamination chamber 102-1 of a size just enough to pass the conveyor unit or conveyor means 155 therethrough. The conveyor means 155 is a part of the system 602 and is configured to feed the product into the decontamination chamber 102-1 via the inlet 120-2 and to output the treated product out of the decontamination chamber 102-1 via the outlet 145-2. The free end of each of the pipes 164 is positioned to disseminate trioxygen gas onto the product on the conveyor means 155 inside the decontamination chamber 102-1.

Further, as shown, the system 600 includes an oxygen generator 108 with a pressure gauge 108a, similar to that of system 600. The trioxygen generator 106 is coupled to the oxygen generator 108 through an oxygen line 122 with a control valve 122a. The control valve 122a controls the rate at which oxygen is passed through the oxygen line 122 to the trioxygen generator 106. The trioxygen generator 106 receives oxygen from the oxygen generator 108 via the oxygen line 122. The trioxygen generator 106 generates trioxygen gas and provides trioxygen gas via trioxygen line 124 to the feedline 128 and from there to the decontamination chamber 102. The trioxygen line 124 has a control valve 124a to control the rate at which the trioxygen gas is passed therethrough. In an example, the feedline 128, the oxygen line 122, and the trioxygen line 124 may be silicon tubes.

Further, as shown in FIG. 6, the trioxygen generator 106 is provided with a pressure gauge 106a, an ammeter 106b, a flow meter 106c, and a current control switch 106d, each of which perform respective functionality as described with respect to the system 100. The trioxygen generator 106 is also coupled with a chiller 146 to control the temperature of the trioxygen generator 106 while it is operating to generate trioxygen gas.

Further, as shown in FIG. 6, the system 600 comprises a liquid disseminator 116-1 that holds a pre-conditioning liquid. The pre-conditioning liquid may include, but is not limited to, H₂O₂ or HOCl or H₂O or citric acid or sodium bi-carbonate or a combination thereof. The system 600 also includes a mist spraying means 154 coupled to the liquid disseminator 116-1 and placed over the conveyor means 155 outside the decontamination chamber 102-1. The mist spraying means 154 is configured to spray the pre-conditioning liquid in the form of mist over the product prior to being fed into the decontamination chamber 102-1.

Further, the system 600 includes a trioxygen destructor 114 coupled to the decontamination chamber 102-1 via an unused trioxygen line 136. The unused trioxygen gas in the decontamination chamber 102-1 is supplied to the trioxygen destructor 114 for converting the trioxygen gas back to oxygen and release the oxygen from the trioxygen destructor 114 through an output line 114a. The unused trioxygen line 136 includes a control valve 136a to control the flow rate of the unused trioxygen gas that is supplied to the trioxygen destructor 114.

The decontamination chamber 102-1 is also provided with a pressure gauge 102c to monitor pressure in the decontamination chamber 102-1. In an example, the decontamination chamber 102-1 may be mounted on a mounting stand 104, as shown.

Further, the system 600 comprises a drying chamber 102-2 having an inlet 120-3 to receive the trioxygen and preconditioning liquid treated product from the decontamination chamber 102-1. The system 600 also includes a hot air compressor 110-3 coupled to the drying chamber 102-2 via one or more hot-air inlets. The hot air compressor 110-3 is configured or operated to provide hot air to the product in the drying chamber 102-2 via the one or more hot-air inlets. The drying chamber 102-2 comprises an outlet 145-3 to output the hot-air dried product.

As shown in FIG. 6, the one or more hot air-inlets comprise one or more pipes 163, where each pipe 163 extends from outer surface of the drying chamber 102-2 towards inside the drying chamber 102-2. One end of each pipe 163 is coupled to a feedline 126 from the hot air compressor 110-3 and another end of the each pipe 163 is a free end inside the drying chamber 102-2 to disseminate hot air onto the product in the drying chamber 102-2.

The pipes 163 have varying lengths inside the drying chamber 102-2 depending on the cross-sectional dimension of the drying chamber 102-2. In an example, each of the pipes 163 has a cross-sectional dimension in a range of about 2.5 cm to 30 cm.

Further, the free end of the one or more pipes 163 is positioned to disseminate hot air into the drying chamber 102-2 from underneath the conveyor means 155 inside the drying chamber 102-2. As shown in FIG. 6, the same conveyor means 155 spans from the inlet side of the decontamination chamber 102-1 up to the outlet 145-3 of the drying chamber 102-2.

As shown in FIG. 6, the hot air compressor 110-1 is coupled to the one or more pipes 163 via a hot air line 126. The hot air compressor 110-3 is operated to provide hot air to the product in the drying chamber 102-2 via the one or more pipes 163. The hot air line 126 has a control valve 126a to control the flow rate of the hot air provided from the hot air compressor 110-2 to the drying chamber 102-2. The hot air compressor 110-3 comprises an air inlet 138-3 coupled to one or more air filters 139-3. The hot air compressor 110-3 is configured to receive air via the air inlet 138-3 which draws filtered air via the one or more air filters 139-3 and to provide hot air to the drying chamber 102-2. The one or more air filters 139-3 are a HEPA filter (4/7) varying in micron size from 500 to 0.2 in series. The hot air compressor 110-1 is provided with a pressure gauge 110a and a temperature gauge 110b. The pressure gauge 110a is to monitor pressure of hot air in the hot air compressor 110-1 and the temperature gauge 110b is to monitor the temperature of the hot air. Alternatively, a cold air compressor can be connected to a heater with a temperature gauge to adjust the required temperature.

Further, the drying chamber 102-2 is provided with a temperature gauge 102b to monitor temperature in the drying chamber 102-2. In an example, the drying chamber 102-2 may be mounted on a mounting stand 104, as shown. Further, the drying chamber 102-2 includes an exhaust line 165-1 for dispensing hot air for the drying chamber 102-2.

In order to maintain desired temperature and pressure in the system 600, the pressure gauges 102c, 106a, 108a, 110a and the temperature gauges 102b, 110b are disposed in the system 600 to operate the control valves 122a in the oxygen line 122, the control valve 124a in trioxygen line 124, the control valve 126a in the hot air line 126, and the control valve 136a in the unused trioxygen line 136.

In an example, any feedline or line described herein may be silicon tubes. In an example, any control valve described herein may be made of plastic, metal, or any other commonly known material.

Further, in an example, as shown FIG. 6, the drying chamber 102-2 is juxtaposed with the decontamination chamber 102-1, where the outlet 142-2 of the decontamination chamber 102-1 and the inlet 120-3 of the dry chamber 102-2 form an air-tight contact with each other. The conveyor means 155 is operated to feed the trioxygen and preconditioning liquid treated product from the decontamination chamber 102-1 into the drying chamber 102-2 and to output the hot-air dried product from the drying chamber 102-2.

Further, no vacuum is required to remove air, prior to introducing trioxygen gas to the decontamination chamber 102.

The description hereinafter describes an exemplary working of the system 600 of FIG. 6. At first, raw and contaminated product is put on the conveyor means 155 and a pre-conditioning liquid is disseminated onto the product through mist spraying mechanism 154 for a first predefined time period in a range of 1 min to 120 mins and at a flow rate of 200 ml/min to 10 liters/min. The product after pre-conditioning is transferred through the conveyor 155 inside the decontamination chamber 102-1 through the inlet 120-2. After this, trioxygen is disseminated onto the product through the pipes 164 for a second predefined time period in a range of 10 seconds to 30 mins. In one example, the trioxygen may be disseminated at a flow rate in a range of 50 lpm to 100 lpm and at a concentration in a range of 0.01 g/kg to 10 g/kg. The unused trioxygen in the decontamination chamber 102-1 is removed through the line 136 and converted back into oxygen by the trioxygen destructor 114. After exposing the product to trioxygen, the product is transferred from the decontamination chamber 102-1 to the drying chamber 102-2. The outlet 145-2 and the inlet 120-3 are in an air-tight connection with each other. Hot air is passed through the pipes 163 from the hot air compressor 110-3 into the drying chamber 102-2 for heat drying the product. The hot air is passed with a flow rate in a range of 10 μm to 100 lpm, at a temperature in a range of 45° C. to 75° C. and for a third pre-defined time period in a range of 10 mins to 60 mins. After heat drying, the resultant product which is free of undesirable contaminants is taken out from the drying chamber 102-2. The product may be outputted from the conveyor means 155. From there, the product may be moved for packaging. In an example, the system 600 may be operated to perform the above-described procedure as a continuous process or a semi-continuous batch process.

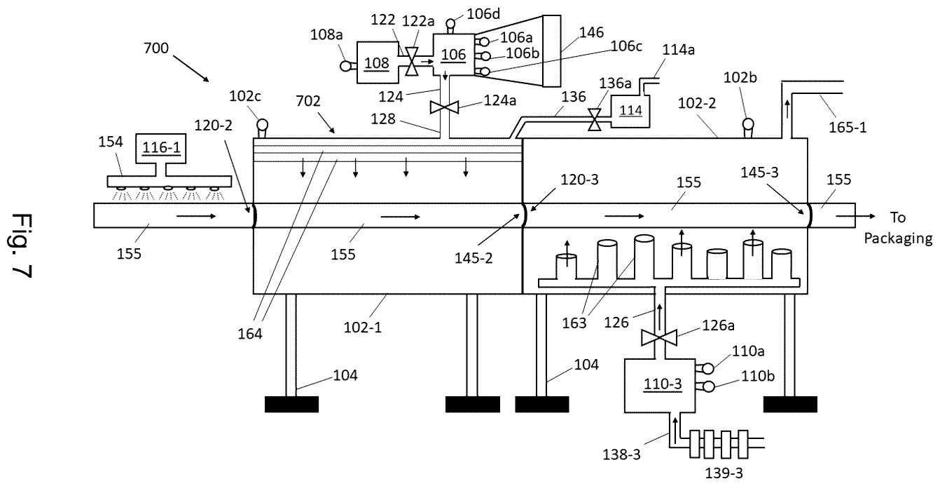

FIG. 7. illustrates a schematic representation of a system for treatment of a product for decontamination of the product, in accordance with an example. The product and decontaminants may be as described earlier in this disclosure. The system 700 includes a decontamination chamber 102-1 having an inlet 120-2 to receive a product which to be treated by the system 700. The inlet 120-2 is an opening in the decontamination chamber 102-1 of a size just enough to pass a conveyor unit or conveyor means 155 therethrough.

The system 700 includes a trioxygen generator 106, similar to that of the system 100, with a feedline 128 through which trioxygen gas is provided into the decontamination chamber 102-1. The system 700 includes multiple first channels 702 in the decontamination chamber 102-1. The multiple first channels 702 are distributed across the longitudinal span of the decontamination chamber 102-1. The multiple first channels 702, as shown in FIG. 7, comprise longitudinal channels 168 lined longitudinally on an inner circumferential surface of the decontamination chamber 102-1. Each of the longitudinal channels 168 is open from a longitudinal side thereof facing inside the decontamination chamber 102-1 to disseminate trioxygen gas onto the product in the decontamination chamber 102-1. Each of the longitudinal channels 168 has an opening coupled to the feedline 128 from the trioxygen generator 106. In an example, each of the longitudinal channels 168 has a cross-sectional dimension in a range of about 1 cm to 30 cm.

As shown in FIG. 7, the feedline line 128 on one side is connected to the trioxygen generator 106 and on the other side coupled to the longitudinal channels 168. The trioxygen generator 106, in its operational state, provides trioxygen gas to the longitudinal channels 168 via the feedline 128 to disseminate trioxygen gas onto the product in the decontamination chamber 102-1.

The system 700, as shown, also includes an outlet 145-2 to output or draw out the trioxygen treated product from the decontamination chamber 102-1. Like the inlet 120-2, the outlet 145-2 is also an opening in the decontamination chamber 102-1 of a size just enough to pass the conveyor unit or conveyor means 155 therethrough. The conveyor means 155 is a part of the system 702 and is configured to feed the product into the decontamination chamber 102-1 via the inlet 120-2 and to output the treated product out of the decontamination chamber 102-1 via the outlet 145-2. The open longitudinal side of each of the longitudinal channels 168 is positioned to disseminate trioxygen gas onto the product on the conveyor means 155 inside the decontamination chamber 102-1.

Further, as shown, the system 700 includes an oxygen generator 108 with a pressure gauge 108a, similar to that of system 700. The trioxygen generator 106 is coupled to the oxygen generator 108 through an oxygen line 122 with a control valve 122a. The control valve 122a controls the rate at which oxygen is passed through the oxygen line 122 to the trioxygen generator 106. The trioxygen generator 106 receives oxygen from the oxygen generator 108 via the oxygen line 122. The trioxygen generator 106 generates trioxygen gas and provides trioxygen gas via trioxygen line 124 to the feedline 128 and from there to the decontamination chamber 102. The trioxygen line 124 has a control valve 124a to control the rate at which the trioxygen gas is passed therethrough. In an example, the feedline 128, the oxygen line 122, and the trioxygen line 124 may be silicon tubes.

Further, as shown in FIG. 7, the trioxygen generator 106 is provided with a pressure gauge 106a, an ammeter 106b, a flow meter 106c, and a current control switch 106d, each of which perform respective functionality as described with respect to the system 100. The trioxygen generator 106 is also coupled with a chiller 146 to control the temperature of the trioxygen generator 106 while it is operating to generate trioxygen gas.

Further, as shown in FIG. 7, the system 700 comprises a liquid disseminator 116-1 that holds a pre-conditioning liquid. The pre-conditioning liquid may include, but is not limited to, H₂O₂ or HOCl or H₂O or citric acid or sodium bi-carbonate or a combination thereof. The system 700 also includes a mist spraying means 154 coupled to the liquid disseminator 116-1 and placed over the conveyor means 155 outside the decontamination chamber 102-1. The mist spraying means 154 is configured to spray the pre-conditioning liquid in the form of mist over the product prior to being fed into the decontamination chamber 102-1.

Further, the system 700 includes a trioxygen destructor 114 coupled to the decontamination chamber 102-1 via an unused trioxygen line 136. The unused trioxygen gas in the decontamination chamber 102-1 is supplied to the trioxygen destructor 114 for converting the trioxygen gas back to oxygen and release the oxygen from the trioxygen destructor 114 through an output line 114a. The unused trioxygen line 136 includes a control valve 136a to control the flow rate of the unused trioxygen gas that is supplied to the trioxygen destructor 114.

The decontamination chamber 102-1 is also provided with a pressure gauge 102c to monitor pressure in the decontamination chamber 102-1. In an example, the decontamination chamber 102-1 may be mounted on a mounting stand 104, as shown.

Further, the system 700 comprises a drying chamber 102-2 having an inlet 120-3 to receive the trioxygen and preconditioning liquid treated product from the decontamination chamber 102-1. The system 700 also includes a hot air compressor 110-3 coupled to the drying chamber 102-2 via one or more hot-air inlets. The hot air compressor 110-3 is configured or operated to provide hot air to the product in the drying chamber 102-2 via the one or more hot-air inlets. The drying chamber 102-2 comprises an outlet 145-3 to output the hot-air dried product.

As shown in FIG. 7, the one or more hot air-inlets comprise one or more pipes 163, where each pipe 163 extends from outer surface of the drying chamber 102-2 towards inside the drying chamber 102-2. One end of each pipe 163 is coupled to a feedline 126 from the hot air compressor 110-3 and another end of the each pipe 163 is a free end inside the drying chamber 102-2 to disseminate hot air onto the product in the drying chamber 102-2. The pipes 163 have varying lengths inside the drying chamber 102-2 depending on the cross-sectional dimension of the drying chamber 102-2. In an example, each of the pipes 163 has a cross-sectional dimension in a range of about 2.5 cm to 30 cm.

Further, the free end of the one or more pipes 163 is positioned to disseminate hot air into the drying chamber 102-2 from underneath the conveyor means 155 inside the drying chamber 102-2. As shown in FIG. 7, the same conveyor means 155 spans from the inlet side of the decontamination chamber 102-1 up to the outlet 145-3 of the drying chamber 102-2.

As shown in FIG. 7, the hot air compressor 110-1 is coupled to the one or more pipes 163 via a hot air line 126. The hot air compressor 110-3 is operated to provide hot air to the product in the drying chamber 102-2 via the one or more pipes 163. The hot air line 126 has a control valve 126a to control the flow rate of the hot air provided from the hot air compressor 110-2 to the drying chamber 102-2. The hot air compressor 110-3 comprises an air inlet 138-3 coupled to one or more air filters 139-3. The hot air compressor 110-3 is configured to receive air via the air inlet 138-3 which draws filtered air via the one or more air filters 139-3 and to provide hot air to the drying chamber 102-2. The one or more air filters 139-3 are a HEPA filter (4/7) varying in micron size from 500 to 0.2 in series. The hot air compressor 110-1 is provided with a pressure gauge 110a and a temperature gauge 110b. The pressure gauge 110a is to monitor pressure of hot air in the hot air compressor 110-1 and the temperature gauge 110b is to monitor the temperature of the hot air. Alternatively, a cold air compressor can be connected to a heater with a temperature gauge to adjust the required temperature.

Further, the drying chamber 102-2 is provided with a temperature gauge 102b to monitor temperature in the drying chamber 102-2. In an example, the drying chamber 102-2 may be mounted on a mounting stand 104, as shown. Further, the drying chamber 102-2 includes an exhaust line 165-1 for dispensing hot air for the drying chamber 102-2.

In order to maintain desired temperature and pressure in the system 700, the pressure gauges 102c, 106a, 108a, 110a and the temperature gauges 102b, 110b are disposed in the system 700 to operate the control valves 122a in the oxygen line 122, the control valve 124a in trioxygen line 124, the control valve 126a in the hot air line 126, and the control valve 136a in the unused trioxygen line 136.

In an example, any feedline or line described herein may be silicon tubes. In an example, any control valve described herein may be made of plastic, metal, or any other commonly known material.

Further, in an example, as shown FIG. 7, the drying chamber 102-2 is juxtaposed with the decontamination chamber 102-1, where the outlet 142-2 of the decontamination chamber 102-1 and the inlet 120-3 of the dry chamber 102-2 form an air-tight contact with each other. The conveyor means 155 is operated to feed the trioxygen and preconditioning liquid treated product from the decontamination chamber 102-1 into the drying chamber 102-2 and to output the hot-air dried product from the drying chamber 102-2.

Further, no vacuum is required to remove air, prior to introducing trioxygen gas to the decontamination chamber 102.

The description hereinafter describes an exemplary working of the system 700 of FIG. 7. At first, raw and contaminated product is put on the conveyor means 155 and a pre-conditioning liquid is disseminated onto the product through mist spraying mechanism 154 for a first predefined time period in a range of 1 min to 120 mins and at a flow rate of 200 ml/min to 10 liters/min. The product after pre-conditioning is transferred through the conveyor 155 inside the decontamination chamber 102-1 through the inlet 120-2. After this, trioxygen is disseminated onto the product through the longitudinal channels 168 for a second predefined time period in a range of 10 seconds to 30 mins. In one example, the trioxygen may be disseminated at a flow rate in a range of 50 lpm to 100 lpm and at a concentration in a range of 0.01 g/kg to 10 g/kg. The unused trioxygen in the decontamination chamber 102-1 is removed through the line 136 and converted back into oxygen by the trioxygen destructor 114. After exposing the product to trioxygen, the product is transferred from the decontamination chamber 102-1 to the drying chamber 102-2. The outlet 145-2 and the inlet 120-3 are in an air-tight connection with each other. Hot air is passed through the pipes 163 from the hot air compressor 110-3 into the drying chamber 102-2 for heat drying the product. The hot air is passed with a flow rate in a range of 10 lpm to 100 lpm, at a temperature in a range of 45° C. to 75° C. and for a third pre-defined time period in a range of 10 mins to 60 mins. After heat drying, the resultant product which is free of undesirable contaminants is taken out from the drying chamber 102-2. The product may be outputted from the conveyor means 155. From there, the product may be moved for packaging. In an example, the system 700 may be operated to perform the above-described procedure as a continuous process or a semi-continuous batch process.

In an example, the system 600, 700 of FIG. 6 or FIG. 7 comprises a tunneling chamber between the decontamination chamber 102-1 and the drying chamber 102-2, where the tunneling chamber is in air-tight connection with proper seal on both sides for entry and exit with the decontamination chamber 102-1 and with the drying chamber 102-2. The conveyor means 155 is to feed the trioxygen and preconditioning liquid treated product from the decontamination chamber 102-1 into the drying chamber 102-2 via the tunneling chamber and to output the hot-air dried product from the drying chamber 102-2.

In an example, the system 600, 700 of FIG. 6 of FIG. 7 comprises a by-pass channel (not shown) between the decontamination chamber 102-1 and the drying chamber 102-2, where the by-pass channel is in air-tight connection with proper seal on both sides for entry and exit with the decontamination chamber 102-1 and with the drying chamber 102-2. The trioxygen and preconditioning liquid treated product from the decontamination chamber 102-1 is passed via the by-pass channel into the drying chamber 102-2 to output the hot-air dried product from the drying chamber 102-2.

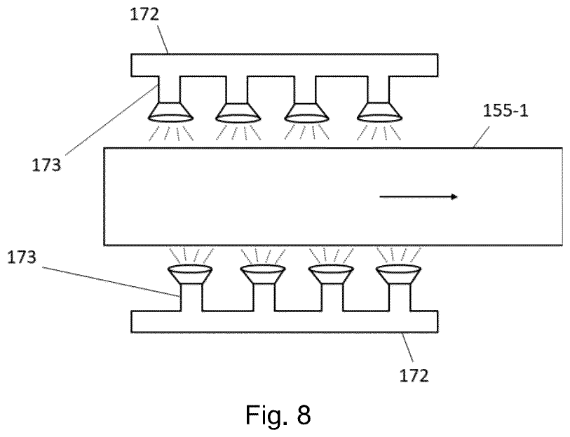

FIG. 8. illustrates an example schematic representation of a conveyor means 155-1 and a liquid dispensing line 172 for the systems of FIG. 6 and FIG. 7. The conveyor means 155-1 may be similar to the conveyor means 155 of FIG. 6 and FIG. 7. The liquid dispensing line 172 may be connected to a liquid disseminator (not shown) and include one or more spraying units 173 that are operable to dispense the pre-conditioning liquid onto the raw and contaminated product from any one side or both sides of the conveyor means 155-1. The liquid dispensing line 172 may dispense the pre-conditioning liquid in a similar manner as that done by the liquid disseminator 116 and the second channel(s) 151, as described with respect to the system 100, 200, 300, 400 of FIG. 1, FIG. 2, FIG. 3, FIG. 4.

It may be understood that the velocity of the conveyor means, described herein, is controlled to ensure thorough pre-conditioning followed by adequate exposure to trioxygen and drying.

Further, in an example, the trioxygen gas is disseminated onto the product in the decontamination chamber 102, 102-1 for a single time or multiple times, sequentially after the dissemination of the pre-conditioning liquid or simultaneously with the pre-conditioning liquid. In an example, the trioxygen gas is disseminated onto the product in the decontamination chamber at a pressure of 1 bar to 2 bar.

In an example, an inert gas including, but not limited to, nitrogen gas and carbon dioxide gas is provided in the decontamination chamber prior to dissemination of the trioxygen gas in the decontamination chamber. This is done to flush out existing air or oxygen in the decontamination chamber and for efficient disbursal of trioxygen gas and maintenance of its concentration for treatment of the product in the decontamination chamber.

The present disclosure also relates to exemplary methods treatment of a product for decontamination of the product, where the product and the decontaminants may be as described earlier in this disclosure.

According to an example method for decontamination of a product, the product inputted into a decontamination chamber of a system (any as described earlier). After this, trioxygen gas is disseminating via multiple first channels distributed across a longitudinal span of the decontamination chamber onto the product. After this, the treated product is outputted from the decontamination chamber.

In an example of the method, a pre-conditioning liquid is disseminated onto the product, where the pre-conditioning liquid comprises H₂O₂ or HOCl or H₂O or citric acid or sodium bi-carbonate or a combination thereof. Further, in an example of the method, hot air is provided to the pre-conditioning liquid and trioxygen gas treated product to dry the product.

In an example of the method, the pre-conditioning liquid and the trioxygen gas are disseminated sequentially, wherein the pre-conditioning liquid is disseminated prior to the dissemination of the trioxygen gas.

In an example of the method, the pre-conditioning liquid and the trioxygen gas are disseminated simultaneously and one or more times. In an example, after the simultaneous dissemination of the pre-conditioning liquid and the trioxygen gas, only the trioxygen gas is disseminated one or more times onto the pre-conditioning liquid and trioxygen gas treated product.

In an example, the pre-conditioning liquid has a concentration in a range of 5 liters per ton of the product to 500 liters per ton of the product. The pre-conditioning liquid may be disseminated via a mist-spraying mechanism, or a liquid-sprayed mechanism, or a wetting mechanism.

In an example, the trioxygen gas is disseminated at a pressure, in the decontamination chamber, in a range of 1 bar to 2 bar and the trioxygen gas is, in the decontamination chamber, in a range of 0.1 gram per kilogram of the product to 35 gram per kilogram of the product.

Further, in an example, the trioxygen gas is disseminated at a time interval in a range of 3 mins to 30 mins and repeatedly for 3 to 50 times.

In an example, the hot air is provided at a temperature in a range of 25° C. to 85° C. and for a time period in a range of 30 mins to 6 hrs.

In an example of the method, an inert gas is provided in the decontamination chamber prior to dissemination of the trioxygen gas in the decontamination chamber. The inert gas comprises, but is not restricted to, nitrogen gas or carbon dioxide gas.

The systems described herein are capable of partially or totally eliminating fat soluble secondary fungal metabolites illustrated in Table-1, microorganisms from food for human consumption, and weevils found in various agricultural products.

TABLE 1
Fat soluble secondary fungal metabolites

| Fat soluble | |
|---|---|
| secondary fungal | |
| metabolites | Structure |
| C₁₇H₁₂O₆ | 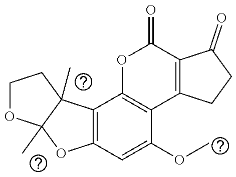 [SMILES: COc1cc2c(c3oc(=O)c4c(c13)CCC4=O)C1(C)CCOC1(C)O2] |
| C₁₇H₁₄O₆ | 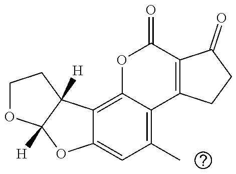 [SMILES: Cc1cc2c(c3oc(=O)c4c(c13)CCC4=O)[C@H]1CCO[C@H]1O2] |
| C₁₇H₁₂O₇ | 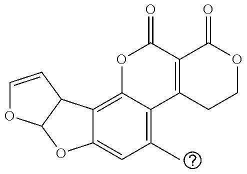 [SMILES: Cc1cc2c(c3oc(=O)c4c(c13)CCOC4=O)C1C=COC1O2] |
| C₁₇H₁₄O₇ | 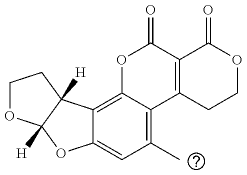 [SMILES: Cc1cc2c(c3oc(=O)c4c(c13)CCOC4=O)[C@H]1CCO[C@H]1O2] |
| C₁₈H₂₂O₅ | 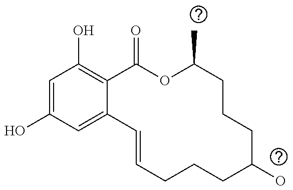 [SMILES: C[C@H]1CCCC(O)CCC/C=C/c2cc(O)cc(O)c2C(=O)O1] |
| C₃₄H₅O₁₅ | 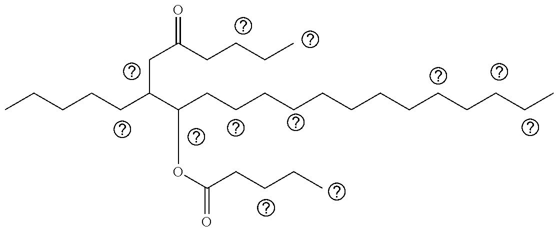 [SMILES: CCCCCCCCCCCCCC(OC(=O)CCCC)C(CCCCC)CC(=O)CCCC] |
| C₇H₆O₄ | 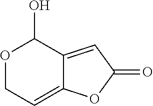 [SMILES: O=C1C=C2C(=CCOC2O)O1] |
| C₁₅H₂₀O₆ | 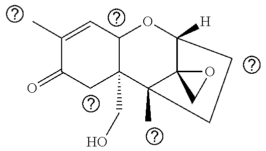 [SMILES: CC1=CC2O[C@@H]3CC[C@](C)([C@@]2(CO)CC1=O)[C@]31CO1] |
| C₁₃H₁₄O₅ | 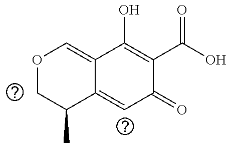 [SMILES: C[C@H]1COC=C2C1=CC(=O)C(C(=O)O)=C2O] |
| C₂₂H₃₂O₈ | 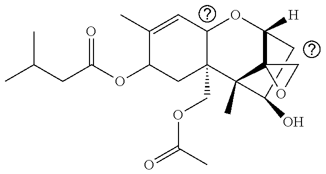 [SMILES: CC(=O)OC[C@]12CC(OC(=O)CC(C)C)C(C)=CC1O[C@@H]1C[C@@H](O)[C@@]2(C)[C@@]12CO2] |
| C₂₀H₁₈ClNO₆ | 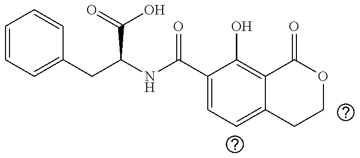 [SMILES: O=C(N[C@@H](Cc1ccccc1)C(=O)O)c1ccc2c(c1O)C(=O)OCC2] |

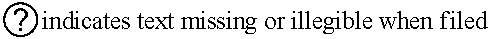

This disclosure describes systems with improved ways of disseminating trioxygen gas and multiple liquids along with air in the required sequence or simultaneously.

Typically, but not limited to, the following products can be decontaminated using the systems of the present disclosure:
Whole grains, such as rice, wheat, corn, rye, barley, durum, quinoa;
Cereals including oats
Edible seeds, such as egusi seeds, melon seeds, watermelon seeds, sunflower seeds, pumpkin seeds;
Nuts, such as groundnuts/peanuts, tiger nuts, pecans, pistachios, hazelnut, walnut, almonds, brazil nut;
Spices, such as pepper (red and black), cardamom, cinnamon, cloves, nutmeg, cumin and coriander, turmeric, ginger, fennel, marjoram, anise, caraway, peppermint; and
Herbs and grasses, such as lemon grass, sumac, chamomile, bay leaf, sage, basil seeds, thyme mint, betel leaves.
Fresh and dehydrated fruits
Fresh and dehydrated vegetables
Meat & meat products
Fish & fish products
Poultry & poultry products
Tea leaves, coffee and cocoa pods

The time and the temperature of the decontamination typically depend upon the moisture content, texture, and nature of the product to be decontaminated. The original organoleptic properties of the products treated are retained to the best possible using the systems of the present disclosure depending on the level of contamination and the contaminant to be eliminate.

The systems described in the present disclosure are capable of decontaminating an agricultural product from a contaminant selected from the group consisting of fungal metabolites such as mycotoxins including the carcinogenic Aflatoxin B1, bacteria, fungi, yeast, pathogenic microorganisms and insect. Live/adult insects, such as weevils can be eliminated and also delayed proliferation of weevil eggs post treatment over time can be achieved. Specific fungi such as Aspergillus parasiticus and Aspergillus flavus and microbial pathogens Salmonella spp. and E. coli spp. are substantially reduced.

Trioxygen on reaction with a contaminant gets converted to O₂, a harmless gas, ensuring environmental friendliness of the decontamination and safe decontaminated product. In the systems described herein trioxygen is quenched in the decontamination chamber. The moisture of the products can be adjusted using the mentioned pre-conditioning liquids.

The present disclosure is further described in the light of the following experiments. Experiments are set forth for illustration purpose only, which are not to be construed for limiting the scope of the disclosure. The following laboratory experiments can be scaled up to industrial/commercial scale and the results obtained can be extrapolated to industrial/commercial scale.

### Experimental Details

### Experiment-1: Decontamination of Whole Red Chilli Using any of the Systems Described in the Description Herein.

This experiment illustrates the treatment of aerobic micro-organisms, yeast, mould, coliform, E. coli, Salmonella and fat soluble metabolites contaminated whole red chilli.

The data presented in Table-2 illustrate the efficacy of the present disclosure in detoxifying contaminated whole red chillies. Sets of whole red chillies of 12 kg's were pre-conditioned and separately decontaminated in the system. 12 kg's of whole red chillies contaminated with aerobic micro-organisms, yeast, mould, coliform, E. coli, Salmonella and fungal metabolites like Aflatoxin B1 were decontaminated in the system post pre-conditioning as per the present disclosure.

The red chillies were exposed with Trioxygen for 2 minutes. The products were put under pressure of trioxygen gas for a span of 9 minutes to 26 minutes. Based on the commodity characteristics, the exposure of trioxygen gas was repeated 10 times. Trioxygen gas having a capacity 500 g/h was generated by the trioxygen generator (on site) of the system with a constant oxygen flow rate and delivered to the decontamination chamber through silicon tube. The whole red chillies were then treated to heated air. All the treated products were analyzed for the presence of the contaminant and the results obtained are summarized in Table-2.

TABLE 2
WHOLE RED CHILLI

| | | | Results | Results | |
|---|---|---|---|---|---|
| Sr. | Wt of | Test | Before | After | % |
| No. | Sample | Parameters | Treatment | Treatment | Reduction |
| Trial | 12 kg's | Aerobic Plate | 9.82 × 10⁸ | 3.0 × 10⁷ | 97% |
| 1 | | Count | cfu/g | cfu/g | |
| | | Yeast & | 1.57 × 10⁷ | 4.18 × 10⁶ | 73% |
| | | Mould Count | cfu/g | cfu/g | |
| | | Coliform | 2.7 × 10⁴ | 1.82 × 10³ | 93% |
| | | Count | cfu/g | cfu/g | |
| | | Salmonella | Present/25 g | Absent/25 g | 100% |
| Trial | 12 kg's | Total Plate | 1.85 × 10⁸ | 3.72 × 10⁷ | 80% |
| 2 | | Count | cfu/g | cfu/g | |
| | | Yeast & Mold | 1.7 × 10⁷ | 2.9 × 10⁶ | 83% |
| | | Count | cfu/g | cfu/g | |
| | | C₁₇H₁₂O₆ | 22.54 ppb | 6.10 ppb | 73% |
| Trial | 12 kg's | Total Plate | 2.4 × 10⁷ | 8.36 × 10⁵ | 97% |
| 3 | | Count | cfu/g | cfu/g | |
| | | Yeast & Mold | 3.36 × 10⁷ | 1.87 × 10⁵ | 99% |
| | | Count | cfu/g | cfu/g | |
| | | Coliform | 5.45 × 10³ | <10 cfu/g | 100% |
| | | Count | cfu/g | | |
| | | Detection of | Present/25 g | Absent/25 g | 100% |
| | | E. coli | | | |
| | | C₁₇H₁₂O₆ | 22.54 ppb | 5.31 ppb | 76% |

It is seen from Table-2, that there is a significant decrease in the contamination using the system and pre-conditioning method of the present disclosure. Further, the original organoleptic properties of the whole red chilli were retained after the treatment.

### Experiment-2: Decontamination of Groundnuts Using any of the Systems Described in the Description Herein.

The data presented in Table-3 illustrates the efficiency of the system of the present disclosure in detoxifying contaminated groundnuts.

Three sets of C₁₇H₁₂O₆ contaminated 3 kg's, 60 kg's and 60 kg's of groundnuts were separately pre-conditioned and decontaminated in the system. In this case, groundnuts were pre-conditioned and exposed with trioxygen gas for up to 5 minutes. The products were put under pressure of trioxygen gas for a span of 9 minutes to 26 minutes. Based on the commodity characteristics, the exposure of trioxygen gas was repeated 15 times. Trioxygen gas having capacity 500 g/h was generated by the trioxygen generator of the system (on site) with a constant oxygen flow rate and delivered to the decontamination chamber through silicon tube. All 3 sets of products were heated and then analyzed for the presence of the contaminant and the results obtained are summarized in Table-3.

TABLE 3
GROUNDNUT

| | | | Results | Results | |
|---|---|---|---|---|---|
| Sr. | Wt of | | Before | After | |
| No. | Sample | Test Parameters | Treatment | Treatment | % Reduction |
| 1 | 3 kg's | C₁₇H₁₂O₆ | 101.84 ppb | Not detected | 100% |
| | | Fatty Acid Profile | | | |
| | | Transfat | <0.1 | <0.1 | — |
| | | Saturated Fat | 10.42% | 10.39% | — |
| | | Monounstaurated | 22.60% | 22.63% | — |
| | | Fatty Acids | | | |
| | | Polyunsaturated | 15.49% | 18.52% | — |
| | | Fatty Acids | | | |
| 2 | 60 kg's | C₁₇H₁₂O₆ | 44.57 ppb | 2.95 ppb | 93% |
| 3 | 60 kg's | C₁₇H₁₂O₆ | 377.69 ppb | 137.53 ppb | 64% |

It is seen from Table-3 that the system of the present disclosure employing trioxygen post pre-conditioning in combination with heated air is capable of effectively degrading C₁₇H₁₂O₆ in groundnuts. There was no change in the fatty acid profile properties in the groundnut after the treatment.

### Experiment-3: Decontamination of Corn Using any of the Systems Described in the Description Herein.

The data presented in Table-4 illustrates the efficiency of the system of the present disclosure in detoxifying pre-conditioned contaminated corn.

Three sets of C₁₇H₁₂O₆ contaminated 70 kg's of corn were separately decontaminated in the system of the present disclosure. In this case, corn samples were pre-conditioned with a pre-conditioning liquid and exposed to trioxygen gas for up to 5 minutes. The products were put under pressure of trioxygen gas for a span of 9 minutes to 26 minutes. Based on the commodity characteristics, the exposure of trioxygen gas was repeated 20 times. Trioxygen gas having capacity 500 g/h was generated by the trioxygen generator of the system (on site) with a constant oxygen flow rate and delivered to the decontamination chamber through silicon tube. All 3 sets of products were air dried and then analyzed for the presence of the contaminant and the results obtained are summarized in Table-4

TABLE 4
CORN

| | | | Results | Results | |
|---|---|---|---|---|---|
| Sr. | Wt of | Test | Before | After | % |
| No. | Sample | Parameters | Treatment | Treatment | Reduction |
| 1 | 70 kg's | C₁₇H₁₂O₆ | 54.20 ppb | Not detected | 100% |
| 2 | 70 kg's | C₁₇H₁₂O₆ | 161.48 ppb | 23.56 ppb | 85% |
| 3 | 70 kg's | C₁₇H₁₂O₆ | 11.03 ppb | Not detected | 100% |

It is seen from Table-4 that the system of the present disclosure employing Trioxygen in combination with the pre-conditioning liquid and drying is capable of effectively degrading C₁₇H₁₂O₆ in corn. There was no change in the organoleptic properties in the corn after the treatment.

### Experiment-4: Decontamination of Grains Using any of the Systems Described in the Description Herein.

The data presented in Table-5 illustrates the efficiency of the system of the present disclosure in pre-conditioning and deactivation of weevils and weevil eggs results in delayed occurrence of insect infestation in grains.

Grains such as Dry corn, Groundnut, Rice & Wheat were separately pre-conditioned and decontaminated in the system of the present disclosure. Grains were exposed to trioxygen gas for up to 5 minutes. The products were put under pressure of trioxygen gas for a span of 9 minutes to 26 minutes. Trioxygen gas having capacity 500 g/h was generated by the trioxygen generator of the system (on site) with a constant oxygen flow rate and delivered to the decontamination chamber through silicon tube. All products were treated with hot air and then analyzed for the presence of the weevils and weevil eggs the results obtained are summarized in Table-5.

TABLE 5a
Shelf-Life Assessment of Corn

| Shelf-Life Assessment | | | 1.5 Months | | 2 Months | | 3 Months | | 5 Months | | 6 Months | | 7 Months | |
|---|---|---|---|---|---|---|---|---|---|---|---|---|---|---|
| Sr. No. | Parameters | Observation | C | T | C | T | C | T | C | T | C | T | C | T |
| 1 | Colour | ✓ Normal; | x | ✓ | x | ✓ | x | ✓ | x | ✓ | x | ✓ | x | ✓ |
| | | x Altered | | | | | | | | | | | | |
| 2 | Visual observation | | | | | | | | | | | | | |
| 2 a) | a. Pin holes | ✓ Not | x | ✓ | x | ✓ | x | ✓ | x | ✓ | x | ✓ | x | ✓ |
| | on grain | observed; | | | | | | | | | | | | |
| | | x Observed | | | | | | | | | | | | |
| 2 b) | b. Powder | ✓ Not | ✓ | ✓ | ✓ | ✓ | x | ✓ | x | ✓ | x | ✓ | x | ✓ |
| | at the | observed; | | | | | | | | | | | | |
| | bottom of | x Observed | | | | | | | | | | | | |
| | bag | | | | | | | | | | | | | |
| 3 | Weevils/ | ✓ Not observed; | x | ✓ | x | ✓ | x | ✓ | x | ✓ | x | x | x | x |
| | Insects | x Observed | | | | | | | | | | | | |

Note:
“C” stands for Control sample & “T” stands for Treated sample

### Remarks on Weevils/Insects

| Months | Control | Treated |
|---|---|---|
| Post 1.5 | Weevils seen - 1 number | No weevils/insects |
| Months | | seen |
| Post 2 | 1 black insect (3 mm) | No weevils/insects |
| Months | observed alive, grains | seen |
| | appeared damaged | |
| Post 3 | 1 black insect (3 mm) | No weevils/insects |
| Months | observed alive, grains | seen |
| | appeared damaged | |
| Post 5 | 5 cream buff coloured insects | No weevils/insects |
| Months | observed which were dead | seen |
| Post 6 | 5 cream buff coloured insects | 1 cream coloured |
| Months | observed which were dead | insect observed alive |
| Post 7 | 3 cream coloured insects | 3 cream coloured |
| Months | observed alive | insect observed alive |

### Observation:

1) Commodity free of infestation at the beginning of experiment
2) Infestation in control sample observed from month 2
3) No weevil infestation in system treated samples up to 6 months
4) Gradual increase in number of weevils in treated sample post 6 months after treatment-Indicates effect of treatment against infestation
5) Number of weevils in treated sample compared to those in control
6) 5 times less (at month 7),
7) 1.5 times less (at month 8),
8) No difference (at month 9)
9) Treatment effective in delaying infestation up to 6 months

TABLE 5b
Shelf-Life Assessment of Groundnut

| Shelf-Life Assessment | | | 1.5 Months | | 2 Months | | 3 Months | | 5 Months | | 6 Months | | 7 Months | |
|---|---|---|---|---|---|---|---|---|---|---|---|---|---|---|
| Sr. No. | Parameters | Observation | C | T | C | T | C | T | C | T | C | T | C | T |
| 1 | Colour | ✓ Normal; | ✓ | ✓ | ✓ | ✓ | ✓ | ✓ | x | ✓ | x | ✓ | x | ✓ |
| | | x Altered | | | | | | | | | | | | |
| 2 | Visual observation | | | | | | | | | | | | | |
| 2 a) | a. Pin holes | ✓ Not | x | ✓ | x | ✓ | x | ✓ | x | ✓ | x | ✓ | x | ✓ |
| | on grain | observed; | | | | | | | | | | | | |
| | | x | | | | | | | | | | | | |
| | | Observed | | | | | | | | | | | | |
| 2 b) | b. Powder | ✓ Not | ✓ | ✓ | x | ✓ | x | ✓ | x | ✓ | x | ✓ | x | ✓ |
| | at the | observed; | | | | | | | | | | | | |
| | bottom of | x | | | | | | | | | | | | |
| | bag | Observed | | | | | | | | | | | | |
| 3 | Weevils/ | ✓ Not | x | ✓ | x | ✓ | x | ✓ | x | ✓ | x | ✓ | x | x |
| | Insects | observed; | | | | | | | | | | | | |
| | | x Observed | | | | | | | | | | | | |

Note:
“C” stands for Control sample & “T” stands for Treated sample

### Remarks on Weevils/Insects

| Months | Control | Treated |
|---|---|---|
| Post 1.5 | 1 insect observed alive, buff/cream - | No weevils/insects |
| Months | 5 mm long and groundnuts look | seen |
| | damaged | |
| Post 2 | 2 black insects (4 mm) observed | No weevils/insects |
| Months | alive | seen |
| Post 3 | Several alive buff/cream -2 mm | No weevils/insects |
| Months | long- insects observed | seen |
| Post 5 | Several alive buff/cream -2 mm | No weevils/insects |
| Months | long- insects observed | seen |
| Post 6 | Several alive buff/cream - 2 mm | No weevils/insects |
| Months | long - dead insects observed. | seen |
| Post 7 | Several alive buff/cream - 2 mm | 1 insect observed - |
| Months | long - dead insects observed. | alive- buff/cream - 5 |
| | | mm long |

### Observation:

1) Commodity free of infestation at the beginning of experiment
2) Infestation in control sample observed from month 1
3) No weevil infestation in system treated samples up to 6 months
4) Infestation in treated sample observed at Month 7-indicates effect of treatment against infestation
5) Number of weevils in treated sample at month 7-3 times less than that in control sample
6) Treatment effective in delaying infestation up to 6 months

TABLE 5c
Shelf-Life Assessment of Rice

| | | | 1.5 | | 2 | | 3 | | 5 | | 6 | | 7 | |
|---|---|---|---|---|---|---|---|---|---|---|---|---|---|---|
| Shelf-Life Assessment | | | Months | | Months | | Months | | Months | | Months | | Months | |
| Sr. No. | Parameters | Observation | C | T | C | T | C | T | C | T | C | T | C | T |
| 1 | Colour | ✓ Normal; | ✓ | ✓ | ✓ | ✓ | ✓ | ✓ | x | ✓ | x | ✓ | x | ✓ |
| | | x Altered | | | | | | | | | | | | |
| 2 | Visual observation | | | | | | | | | | | | | |
| 2 a) | a. Pin holes | ✓ Not | ✓ | ✓ | ✓ | ✓ | ✓ | ✓ | ✓ | ✓ | ✓ | ✓ | ✓ | ✓ |
| | on grain | observed; | | | | | | | | | | | | |
| | | x Observed | | | | | | | | | | | | |
| 2 b) | b. Powder | ✓ Not | ✓ | ✓ | ✓ | ✓ | ✓ | ✓ | x | ✓ | x | ✓ | x | ✓ |
| | at the | observed; | | | | | | | | | | | | |
| | bottom of | x Observed | | | | | | | | | | | | |
| | bag | | | | | | | | | | | | | |
| 3 | Weevils/ | ✓ Not observed; | ✓ | ✓ | x | ✓ | x | ✓ | x | ✓ | x | ✓ | x | x |
| | Insects | x Observed | | | | | | | | | | | | |

Note:
“C” stands for Control sample & “T” stands for Treated sample

### Remarks on Weevils/Insects

| Months | Control | Treated |
|---|---|---|
| Post 1.5 | No weevils/insects seen | No weevils/insects seen |
| Months | | |
| Post 2 | 1 black insect (3 mm) and 1 | No weevils/insects seen |
| Months | light brown insect (3 | |
| | mm)observed alive | |
| Post 3 | 1 black insect (3 mm) and 1 | No weevils/insects seen |
| Months | cream insect (3 mm) | |
| | observed alive | |
| Post 5 | 2 black insects (3 mm) were | No weevils/insects seen |
| Months | observed alive | |
| Post 6 | 2 black insects (3 mm) were | No weevils/insects seen |
| Months | observed alive | |
| Post 7 | 2 black insects (3 mm) were | 1 small cream coloured |
| Months | observed alive | insects and 1 black insect |
| | | alive |

### Observation:

1) Commodity free of infestation at the beginning of experiment
2) Infestation in control sample observed from month 2
3) No weevil infestation in system treated samples up to 6 months
4) Infestation in treated sample observed at Month 7-indicates effect of treatment against infestation after this time period
5) Treatment effective in delaying infestation up to 6 months

TABLE 5d
Shelf-Life Assessment of Wheat

| | | | 1.5 | | 2 | | 3 | | 5 | | 6 | | 7 | |
|---|---|---|---|---|---|---|---|---|---|---|---|---|---|---|
| Shelf-Life Assessment | | | Months | | Months | | Months | | Months | | Months | | Months | |
| Sr. No. | Parameters | Observation | C | T | C | T | C | T | C | T | C | T | C | T |
| 1 | Colour | ✓ Normal; | ✓ | ✓ | ✓ | ✓ | ✓ | ✓ | ✓ | ✓ | ✓ | ✓ | ✓ | ✓ |
| | | x Altered | | | | | | | | | | | | |
| 2 | Visual observation | | | | | | | | | | | | | |
| 2 a) | a. Pin holes | ✓ Not | x | ✓ | x | ✓ | x | ✓ | x | ✓ | x | ✓ | x | ✓ |
| | on grain | observed; | | | | | | | | | | | | |
| | | x Observed | | | | | | | | | | | | |
| 2 b) | b. Powder | ✓ Not | x | ✓ | x | ✓ | x | ✓ | x | ✓ | x | ✓ | x | ✓ |
| | at the | observed; | | | | | | | | | | | | |
| | bottom of | x Observed | | | | | | | | | | | | |
| | bag | | | | | | | | | | | | | |
| 3 | Weevils/ | ✓ Not | x | ✓ | x | ✓ | x | ✓ | x | x | x | x | x | x |
| | Insects | observed; | | | | | | | | | | | | |
| | | x Observed | | | | | | | | | | | | |

Note: “C” stands for Control sample & “T” stands for Treated sample

### Remarks on Weevils/Insects

| Months | Control | Treated |
|---|---|---|
| Post 1.5 | 1 insect observed alive - | No weevils/insects |
| Months | black 3 mm | seen |
| Post 2 | 3 black insects (3 mm) | No weevils/insects |
| Months | observed alive | seen |
| Post 3 | 2 black insects (3 mm) and 1 | No weevils/insects |
| Months | cream/buff colour insect (3 | seen |
| | mm) observed alive | |
| Post 5 | 8 black insects (3 mm) | 2 cream/buff colour |
| Months | observed alive | insect (3 mm) observed |
| | | alive |
| Post 6 | 9 black insects (3 mm) | 3 cream/buff colour |
| Months | observed alive | insect (3 mm) observed |
| | | alive |
| Post 7 | 9 black insects (3 mm) | 3 cream/buff colour |
| Months | observed alive&15 cream/ | insect (3 mm) observed |
| | buff colour (2 mm) insects | alive |
| | observed alive | |

### Observation:

1) Commodity free of infestation at the beginning of experiment
2) Infestation in control sample observed from month 1
3) No weevil infestation in system treated samples up to 3 months
4) Number of weevils in treated sample compared to those in control Treatment 4 times less (at month 5)
5) Treatment effective in delaying infestation up to 6 months

It is seen from Table-5 that the system of the present disclosure employing Trioxygen in combination with heat is capable of effectively deactivating the weevils and weevil eggs results in delayed occurrence of insect infestation in grains. There was no change in the organoleptic properties of the grain after the treatment.

### Experiment-5: Decontamination of Whole Red Chilli Using any of the Systems Described in the Description Herein.

This experiment illustrates the treatment of whole red chilli contaminated with pesticide residues.

The data presented in Table-6 illustrates the efficacy of the present disclosure in detoxifying contaminated whole red chillies. Sets of whole red chillies of 12 kg's contaminated with pesticides like Azoxystrobin, Imidacloprid Novaluron and Myclobutanil were used for the experiment. An inert gas (Nitrogen & Carbon-di-oxide) were introduced into the chamber filled with the material to drive out existing air and oxygen in the chamber. Pre-conditioning was carried out with HOCL and trioxygen being introduced simultaneously in decontamination chamber with faster decontamination process in the system with a shorter timeline protocol.

The red chillies were exposed with HOCL and Trioxygen simultaneously for 2 minutes. The products were put under pressure of 2 bar of trioxygen gas for a span of 9 minutes to 26 minutes. Based on the commodity characteristics, the exposure of trioxygen gas was repeated 10 times. Trioxygen gas having a capacity 500 g/h was generated by the trioxygen generator (on site) of the system with a constant oxygen flow rate and delivered to the decontamination chamber through silicon tube. The whole red chillies were then treated to heated air. All the treated products were analyzed for the presence of the contaminant and the results obtained are summarized in Table-6.

TABLE 6
WHOLE RED CHILLI

| | | | Results | Results | |
|---|---|---|---|---|---|
| Sr. | Wt of | Test | Before | After | % |
| No. | Sample | Parameters | Treatment | Treatment | Reduction |
| Trial | 12 kg's | Azoxystrobin | 0.114 mg/kg | 0.043 mg/kg | 62% |
| 1 | | Imidacloprid | 0.098 mg/kg | 0.060 mg/kg | 40% |
| | | Novaluron | 0.036 mg/kg | Not detected | 100% |
| | | Myclobutanil | 0.087 mg/kg | Not detected | 100% |

It is seen from Table-6 that the system of the present disclosure employing Trioxygen in combination with the pre-conditioning liquid followed by repeated trioxygen exposure, followed by drying is capable of effectively degrading pesticides like Azoxystrobin, Imidacloprid, Novaluron and Carbendazim in whole red chilli.

### Technical Advancements

The systems described herein have several technical advantages including, but not limited to, decontaminating commercial volumes of agricultural products. The innovation in the systems described herein is that it works on multiple contaminants at the same time, where contaminants include fungal metabolites like Aflatoxins, microbial pathogens and weevils and other insects. The systems of the present disclosure increase the safety and the shelf life of the treated product and at the same time retain the original organoleptic properties of the product that is treated. Further, the systems of the present disclosure are rapid and effective and can be scaled to a commercial level.

Throughout this specification the word “comprise” and “include”, or variations such as “comprises” or “comprising” or “includes” or “including”, will be understood to imply the inclusion of a stated element, integer or step, or group of elements, integers or steps, but not the exclusion of any other element, integer or step, or group of elements, integers or steps.

The use of the expression “at least” or “at least one” or “one or more” suggests the use of one or more elements or ingredients or quantities, as the use may be in the embodiment of the present subject matter to achieve one or more of the desired objects or results. While certain embodiments of the present subject matter have been described, these embodiments have been presented by way of examples only and are not intended to limit the scope of the inventions. Variations or modifications to the formulation of the present subject matter, within the scope of the present subject matter, may occur to those skilled in the art upon reviewing the disclosure herein. Such variations or modifications are well within the spirit and scope of the subject matter described herein.

The numerical values given for various physical parameters, dimensions, and quantities are only approximate values and it is envisaged that the values higher than the numerical value assigned to the physical parameters, dimensions and quantities fall within the scope of the invention unless there is a statement in the specification to the contrary.

While considerable emphasis has been placed herein on the specific features of the preferred embodiment, it will be appreciated that many additional features can be added and that many changes can be made in the preferred embodiment without departing from the principles of the present disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

1.-44. (canceled)

45. A system for treatment of a product for decontamination of the product, the system comprising:
a liquid disseminator that holds a pre-conditioning liquid;
a decontamination chamber having an inlet to receive the product;
multiple first channels in the decontamination chamber, wherein the multiple first channels are distributed across the longitudinal span of the decontamination chamber;
a trioxygen generator with a feedline coupled to the multiple first channels, wherein the trioxygen generator is to provide trioxygen gas to the multiple first channels to disseminate trioxygen gas onto the product in the decontamination chamber;
an outlet to output the trioxygen treated dried product; and
an independent drying chamber having an inlet to receive the trioxygen and preconditioning liquid treated product from the decontamination chamber.

46. The system as claimed in claim 45, wherein the pre-conditioning liquid comprises H₂O₂ or HOCl or H₂O or citric acid or sodium bi-carbonate or a combination thereof; and wherein the system comprises:
at least one second channel lined inside the decontamination chamber along a longitudinal dimension of the decontamination chamber;
wherein the at least one second channel has orifices and is coupled to the liquid disseminator to receive the pre-conditioning liquid and disseminate the pre-conditioning liquid onto the product via the orifices, wherein the orifices are of a size in a range of about 0.1 mm to about 50 mm, and wherein one or more of the orifices have a mesh to control the product, being treated, from entering the orifices;
wherein the multiple first channels comprise:
at least one longitudinal channel coupled to the feedline and having orifices to disseminate trioxygen gas onto the product in the decontamination chamber, wherein the at least one longitudinal channel has a cross-sectional dimension in a range of about 10 cm to about 50 cm;
a set of sub-channels coupled to the at least one longitudinal channel and having orifices to disseminate trioxygen gas onto the product in the decontamination chamber, wherein each sub-channel of the set of sub-channels subtends an angle in a range of about 30° to about 90° with respect to the respective longitudinal channel;
a hot air compressor coupled to the drying chamber via one or more hot-air inlets;
wherein the hot air compressor comprises an air inlet coupled to one or more air filters;
wherein the hot air compressor is to provide hot air to the product in the drying chamber via the one or more hot-air inlets; and
wherein the drying chamber comprises an outlet to output the hot-air dried product.

47. The system as claimed in claim 46, wherein the system comprises:
at least one longitudinal channel coupled to the liquid disseminator to receive the pre-conditioning liquid and disseminate the pre-conditioning liquid onto the product via the orifices; and
a gear box coupled to the feedline and the at least one longitudinal channel, wherein the gear box is to rotate the at least one longitudinal channel and the set of sub-channels for movement of the product inside the decontamination chamber.

48. The system as claimed in claim 45, wherein the system comprises:
a hot air compressor coupled to the feedline, wherein the hot air compressor is to provide hot air to the product in the decontamination chamber via the orifices of the at least one longitudinal channel and the set of sub-channels, and wherein the hot air compressor comprises an air inlet coupled to one or more air-filters.

49. The system as claimed in claim 48, wherein the system comprises:
a liquid disseminator that holds a pre-conditioning liquid comprising H₂O₂ or HOCl or H₂O or citric acid or sodium bi-carbonate or a combination hereof; and a conveyor means, wherein conveyor means is to feed the product into the decontamination chamber via the inlet thereof and to output the treated product out of the decontamination chamber via the outlet thereof;
wherein the free end of each of the pipes is positioned to disseminate trioxygen gas onto the product on the conveyor means inside the decontamination chamber; or
wherein the open longitudinal side of each of the longitudinal channels is positioned to disseminate trioxygen gas onto the product on the conveyor means inside the decontamination chamber;
a mist spraying means coupled to the liquid disseminator and placed over the conveyor means outside the decontamination chamber;
wherein the mist spraying means is to spray the pre-conditioning liquid in the form of mist over the product prior to being fed into the decontamination chamber;
wherein the multiple first channels comprise:
longitudinal channels lined longitudinally on an inner circumferential surface of the decontamination chamber;
wherein each of the longitudinal channels is open from a longitudinal side thereof facing inside the decontamination chamber to disseminate trioxygen gas onto the product in the decontamination chamber;
wherein each of the longitudinal channels has an opening coupled to the feedline from the trioxygen generator;
wherein each of the longitudinal channels has a cross-sectional dimension in a range of about 1 cm to 30 cm;
wherein the multiple first channels further comprise:
pipes extending from inside of the decontamination chamber towards the outer surface of the decontamination chamber;
wherein one end of each of the pipes is coupled to the feedline from the trioxygen generator and another end of the each of the pipes is a free end inside the decontamination chamber to disseminate trioxygen gas onto the product in the decontamination chamber;
wherein the pipes have varying lengths inside the decontamination chamber depending on the cross-sectional dimension of the decontamination chamber;
wherein each of the pipes has a cross-sectional dimension in a range of about 1 cm to 30 cm;
wherein pipes are covered with a mesh to prevent entry of product into the channels;
a drying chamber having an inlet to receive the trioxygen and preconditioning liquid treated product from the decontamination chamber;
a hot air compressor coupled to the drying chamber via one or more hot-air inlets;
wherein the hot air compressor is to provide hot air to the product in the drying chamber via the one or more hot-air inlets, and
wherein the drying chamber comprises an outlet to output the hot-air dried product; and
wherein all the orifices present in chambers whether internal or on the walls are to disseminate trioxygen gas, disseminating liquids singly or in combination.

50. The system as claimed in claim 49, wherein the drying chamber is juxtaposed with the decontamination chamber, wherein the outlet of the decontamination chamber and the inlet of the dry chamber form an air-tight contact with each other, and wherein the conveyor means is to feed the trioxygen and preconditioning liquid treated product from the decontamination chamber into the drying chamber and to output the hot-air dried product from the drying chamber, and wherein the hot air compressor comprises an air inlet coupled to one or more air-filters, and wherein the one or more hot air-inlets comprise one or more pipes, wherein each pipe extends from outer surface of the drying chamber towards inside the drying chamber, wherein one end of each pipe is coupled to a feedline from the hot air compressor and another end of the each pipe is a free end inside the drying chamber to disseminate hot air onto the product in the drying chamber, and wherein the pipes have varying lengths inside the drying chamber depending on the cross-sectional dimension of the drying chamber.

51. The system as claimed in claim 50, wherein each of the pipes has a cross-sectional dimension in a range of about 2.5 cm to 30 cm, wherein the free end of the one or more pipes is positioned to disseminate hot air into the drying chamber from underneath the conveyor means inside the drying chamber.

52. The system as claimed in claim 46, wherein the at least one second channel is coupled to the feedline to disseminate trioxygen gas onto the product in the decontamination chamber.

53. The system as claimed in claim 49, wherein the system comprises:
a tunneling chamber between the decontamination chamber and the drying chamber, wherein the tunneling chamber is in air-tight connection with the decontamination chamber and with the drying chamber, and wherein the conveyor means is to feed the trioxygen and preconditioning liquid treated product from the decontamination chamber into the drying chamber via the tunneling chamber and to output the hot-air dried product from the drying chamber.

54. The system as claimed in claim 45, wherein the trioxygen gas is disseminated onto the product in the decontamination chamber for a single time or multiple times at a pressure of 1 bar to 2 bar.

55. The system as claimed in claim 46, wherein the orifices are of a size in a range of about 0.2 mm to about 90 mm.

56. The system as claimed in claim 45, wherein the system comprises:
a gear box coupled to the decontamination chamber, wherein the gear box is to rotate the decontamination chamber for movement of the product inside the decontamination chamber.

57. The system as claimed in claim 45, wherein the system comprises:
one or more baffles inside the decontamination chamber for movement of product inside the decontamination chamber.

58. A method for treatment of a product for decontamination of the product, the method comprising:
disseminating a pre-conditioning liquid onto the product;
inputting the product into a decontamination chamber;
disseminating via multiple first channels distributed across a longitudinal span of the decontamination chamber trioxygen gas onto the product;
outputting the treated product from the decontamination chamber; and
providing hot air to the pre-conditioning liquid and trioxygen gas treated product to dry the product.

59. The method as claimed in claim 58, wherein the pre-conditioning liquid comprises H₂O₂ or HOCl or H₂O or citric acid or sodium bi-carbonate or a combination thereof, wherein the pre-conditioning liquid and the trioxygen gas are disseminated sequentially, wherein the pre-conditioning liquid is disseminated prior to the dissemination of the trioxygen gas.

60. The method as claimed in claim 59, wherein the pre-conditioning liquid and the trioxygen gas are disseminated simultaneously and one or more times, wherein the trioxygen gas is disseminated one or more times onto the pre-conditioning liquid and trioxygen gas treated product.

61. The method as claimed in claim 59, wherein the pre-conditioning liquid has a concentration in a range of 5 liters per ton of the product to 500 liters per ton of the product, wherein the pre-conditioning liquid is disseminated via one of a mist-spraying mechanism, a liquid-sprayed mechanism and a wetting mechanism.

62. The method as claimed in claim 58, wherein the trioxygen gas is disseminated at a pressure, in the decontamination chamber, in a range of 1 bar to 2 bar and the trioxygen gas is, in the decontamination chamber, in a range of 0.1 gram per kilogram or the product to 35 gram per kilogram of the product, wherein the trioxygen gas is disseminated at a time interval in a range of 3 mins to 30 mins and repeatedly for 3 to 50 times, and wherein in the decontamination chamber, an inert gas prior to dissemination of the trioxygen gas in the decontamination chamber.

63. The method as claimed in claim 62, wherein the inert gas comprises nitrogen gas or carbon dioxide gas.

64. The method as claimed in claim 58, wherein the hot air is provided at a temperature in a range of 25° C. to 85° C. and for a time period in a range of 30 mins to 6 hrs.
